(19) United States
(12) Patent Application Publication
(10) Pub. No.: US 2025/0346737 A1
(43) Pub. Date: Nov. 13, 2025

(54) RADIATION INDUCED RADICAL CURING BY SEMICONDUCTING NANOPARTICLES

(71) Applicants: YEDA RESEARCH AND DEVELOPMENT CO. LTD., Rehovot (IL); SHENKAR COLLEGE OF ENGINEERING AND DESIGN, Ramat Gan (IL)

(72) Inventors: Reshef TENNE, Rehovot (IL); Hanna DODIUK-KENIG, Haifa (IL); Shmuel KENIG, Haifa (IL); Natali YOSEF TAL, Tel Aviv (IL); Raanan CARMIELLI, Rehovot (IL)

(73) Assignees: YEDA RESEARCH AND DEVELOPMENT CO. LTD., Rehovot (IL); SHENKAR COLLEGE OF ENGINEERING AND DESIGN, Ramat Gan (IL)

(21) Appl. No.: 18/862,677

(22) PCT Filed: May 10, 2023
(86) PCT No.: PCT/IL2023/050488

§ 371 Date: Nov. 4, 2024

(30) Foreign Application Priority Data
May 10, 2022 (IL) 292915

(51) Int. Cl. C08K 7/06; C08F 120/12

(52) U.S. Cl. CPC C08K 7/06; C08F 120/12

(57) ABSTRACT

This present invention is directed towards radiation-induced radical curing by semiconducting nanoparticles, to thermoset resins and method of preparation thereof. In particular a pure monomeric suspension is utilized without comprising water.

### FIELD OF THE INVENTION

This invention is directed to radical curing by semiconducting nanoparticles, to thermoset resins and method of preparation thereof.

### BACKGROUND OF THE INVENTION

Curing of polymers by UV light is investigated for many years and is currently of great technological importance in for example dentistry, advanced manufacturing (3D-printing) and for diverse applications such as manufacturing of optical media, bio- and medical technology and more. Radiation curing of thermoset resins offers various advantages, including curing on-demand, low viscosity, good surface adhesion to various substrates, high modulus, good appearance of the final coating, zero-volatile organic compounds (VOC), etc. However, radiation curing thermosets are brittle and the process is limited to low thickness and transparent formulations.

There are different photo-curing mechanisms including cationic and radical [1], [2]. Acrylates are versatile thermosets resins which exhibits diverse functionality depending on their chemical structure e.g., poly (ester acrylate), poly (urethane acrylate) etc. [3], [4]. Acrylates can undergo radical photo-curing reaction through their double bonds.

Cationic curing (CC) of epoxy is accomplished through ring opening mechanism (ROP)[1]-[7] initiated by radical formation [8], [9] generated by photolysis of photo-initiators (PIs). The photolysis-based products essentially generate a radical moiety followed by formation of cationic moiety, which initiates the ROP curing of the epoxy. Specifically, upon direct photolysis of the PI, the onium salt dissociates into anionic moiety, which evolves into a strong acid by abstracting hydrogen from adjacent monomer and forming a cationic moiety. The anionic moiety stabilizes the positive charge generated on the epoxide ring. At this point propagation starts by nucleophilic attack of an adjacent oxygen by the positively charged oxirane ring. The propagation step is efficient due to a combined effect of the positively charged oxirane ring and thermodynamically driven ring opening. Thus, polymerization may continue even in the absence of radiation after the initiation stage.

Radiation curing of epoxy is carried-out through cationic mechanism of ring-opening reactions, while acrylate resins are photocured via radical mechanism [5]. The photocuring process is highly selective due to a specific absorption spectra of the photo-initiator, which are sensitive to certain wavelengths, only [6] [1].

Semiconductors (SC), with lower bandgap (0.7-3.5 eV) exhibit reasonable conductivity (resistivity of 10³-10⁻³ Ohm cm) because a fraction of the highest valence electrons reside in the conduction band and are free to move. The density of free electrons in the conduction band of a SC is described by the Fermi level, which is the electrochemical potential of the (free) electrons. Without going into mathematics, it can be said that if the SC is doped with electron rich atoms (like indium in CdSe, or arsine in silicon), i.e., 10 ppm (0.001 at %) of the impurity is added to the SC, then n=10¹⁷ cm⁻³ (and p=10⁵ cm⁻³) and the Fermi level is close to the conduction band and the SC is electron-rich (n-type semiconductor). The conductivity increases by a factor of 10⁴, i.e. to 1 Ohm·cm. The opposite process occurs when a p-type dopant is added.

Low bandgap materials like WS₂ and MoS₂ with absorption edge below about 630-660 nm (1.95-1.85 eV)⁶ appear almost black giving a strong hue to the solution. This effect could block the light from deeply penetrating the polymer film slowing down the photocuring of the deep polymer layers.

Being a semiconductor, WS₂ NPs exhibit high absorbance in UV/near-visible light [7]. WS₂ shows an indirect bandgap of 1.3 e V and a direct gap of 2.05 eV [8]. The absorption is characterized by two excitonic transitions, i.e. the A exciton at 625-630 nm (2 eV) and the B exciton at 520 nm (2.24 eV). [9] [10] Exposure of the NPs to light of appropriate wavelength results in an enabling photovoltaic effect where the absorption of light produces holes and electrons, which are separated by the built-in electric field of the NPs. Hydroxyl radicals (reduction) and H⁺ ions (oxidation) can be generated at the semiconductor surface in contact with moisture [11]. These free radicals are highly reactive and can accelerate radical curing.

One remarkable property of illuminated semiconductors is that, in contrast to dye molecules, they absorb light at any energy above the bandgap. However, in a matter of a femtosecond time interval the excited electrons thermalize into the conduction band edge and their oxidation (reduction) power is determined by the bandgap of the semiconductor. This means that, if excited by UV light, low bandgap materials, like WS₂ will have oxidative power not larger that their bandgap. For example, in contrast to illuminated TiO₂, WS₂ cannot split water, because its conduction band edge is not positioned sufficiently high to reduce water into hydrogen.

Semiconductors are made of anions and cations with different level of covalency (ionicity). Oxides, like TiO₂, are very ionic (low level of covalency) and chalcogenides, like CdS or pnictides (GaN) are less ionic in general and are mostly covalent. This difference has a marked effect on the mechanism of electronic conduction; thermodynamic stability, etc. Anions have relatively high electronegativity (electron acceptors), and they contribute most of their electron density to the valence band. The cations contribute most of their electrical affinity to the conduction band. Semiconductors are mostly grown at high temperatures (otherwise they are full of defects, and they exhibit poor electronic properties). At high temperatures, the entropy term in the free energy is very large and hence most SC are rich in vacancies. Trivially, the anions are always more volatile, which means that most high-temperature grown compound SC are metal-rich, i.e. they are n-type semiconductors. This means that semiconductors cannot be absolutely intrinsic, and they (almost) always have excess electrons, i.e. they are naturally n-type materials. Hence, in contact with electrolyte their bands are bent upwards, i.e. if illuminated-holes diffuse to the surface and carry out oxidation reaction. This situation is true for TiO₂, CdSe and WS₂ as well.

Thus, UV irradiation of WS₂ nanotubes or fullerenes cannot sensitize the dye molecules directly because their energy gap (2.05 eV=610 nm) is appreciably lower than the original UV irradiation. However, they can form superoxide (O₂·) or OH·Radicals, by oxidizing water with the surface holes in the edge of the conduction band. These OH·Radicals are able to initiate the chain-reaction.

The properties of nanocomposites are affected by the NPs' size, shape, and most importantly, the physio-chemical affinity to the polymer matrix. The interface controls the degree of interaction between the particles and the matrix. By reducing the tendency of the NPs to agglomerate; properly dispersing them in the matrix, as well as controlling the interface interaction, an efficient stress transfer from the matrix to the NPs can be achieved. Under such circumstances, the load bearing capacity of the nanocomposite, can be largely improved. Upon reducing their diameter, the specific surface area (surface area per unit weight) of the NPs increases like 1/diameter. Therefore, in general, the stress transfer from the matrix to the NPs increases upon reducing the NPs diameter (radius).

WS₂ nanoparticles (NPs) with fullerene-like structure (IF) and nanotubes thereof were first synthesized in 1992 [12]. They were found suitable for improving the mechanical and thermal properties of polymers upon adding low percentage of the NPs to the nanocomposite material [13] [14] [15] [16] [17] [18].

Surprisingly, it was found that fullerene-like NP and nanotubes of WS₂ can be used as a photo initiator, enhancing the degree of conversion (DC) when incorporated with a monomeric radical curable unit to obtain a thermoset resin.

### REFERENCES

[1] J. V. Crivello, M. Sangermano, Visible and Long-Wavelength Photoinitiated Cationic Polymerization, J. Polym. Sci. Part A Polym. Chem. 39 (2001) 343-356. https://doi.org/10.1002/1099-0518(20010201)39:3<343::AID-POLA1001>3.0.CO;2-J.
[2] I. Dashan, D. K. Balta, B.A. Temel, and G. Temel, “Preparation of single chain nanoparticles via photoinduced radical coupling process,” Eur. Polym. J., vol. 113, no. November 2018, pp. 183-191, 2019.
[3] D. Kunwong, N. Sumanochitraporn, and S. Kaewpirom, “Curing behavior of a UV-curable coating based on urethane acrylate oligomer: the influence of reactive monomers,” Songklanakarin J. Sci. Technol, vol. 33, no. 2, pp. 201-207.
[4] W. Auwärter, “Hexagonal boron nitride monolayers on metal supports: Versatile templates for atoms, molecules and nanostructures,” Surf. Sci. Rep., vol. 74, no. 1, pp. 1-95, March 2019.
[5] V. Kottisch, Q. Michaudel, B.P. Fors, Photocontrolled Interconversion of Cationic and Radical Polymerizations, J. Am. Chem. Soc. 139 (2017) 10665-10668. https://doi.org/10.1021/jacs.7b06661.
[6] B. Aydogan, B. Gacal, A. Yildirim, N. Yonet, Y. Yuksel, 17. Wavelength tunability in photoinitiated cationic polymerization, Photochem. UV Curing New Trends. 661 (2006).
[7] A. Fakhri, V.K. Gupta, H. Rabizadeh, S. Agarwal, N. Sadeghi, S. Tahami, Preparation and characterization of WS2 decorated and immobilized on chitosan and polycaprolactone as biodegradable polymers nanofibers: Photocatalysis study and antibiotic-conjugated for antibacterial evaluation, Int. J. Biol. Macromol. 120 (2018) 1789-1793. https://doi.org/10.1016/j.ijbiomac.2018.09.207.
[8] K.K. Kam, B.A. Parkinson, Detailed photocurrent spectroscopy of the semiconducting group VI transition metal dichalcogenides, J. Phys. Chem. 86 (1982) 463-467. https://doi.org/10.1021/j100393a010.
[9] G. Frey, S. Elani, Optical-absorption spectra of inorganic fullerenelike W), Phys. Rev. B-Condens. Matter Mater. Phys. 57 (1998) 6666-6671. https://doi.org/10.1103/PhysRevB.57.6666.
[10] F. Kopnov, A. Yoffe, G. Leitus, R. Tenne, Transport properties of fullerene-like WS2 nanoparticles, Phys. Status Solidi Basic Res. 243 (2006) 1229-1240. https://doi.org/10.1002/pssb.200541170.
[11] S. Merci, A. Saljooqi, T. Shamspur, A. Mostafavi, Investigation of photocatalytic chlorpyrifos degradation by a new silica mesoporous material immobilized by WS2 and Fe3O4 nanoparticles: Application of response surface methodology, Appl. Organomet. Chem. 34 (2020) 1-14. https://doi.org/10.1002/aoc.5343.
[12] R. Tenne, L. Margulis, G. Hodes, Fullerene-like nanocrystals of tungsten disulfide, Adv. Mater. 5 (1993) 386-388. https://doi.org/10.1002/adma.19930050513.
[13] M. Shneider, H. Dodiuk, S. Kenig, R. Tenne, The effect of tungsten sulfide fullerene-like nanoparticles on the toughness of epoxy adhesives, J. Adhes. Sci. Technol. 24 (2010) 1083-1095. https://doi.org/10.1163/016942409X12584625925268.
[14] G. Goldberg, H. Dodiuk, S. Kenig, R. Cohen, R. Tenne, The effect of tungsten disulfide nanotubes on the properties of silicone adhesives, Int. J. Adhes. Adhes. 55 (2014) 77-81. https://doi.org/10.1016/j.ijadhadh.2014.07.001.
[15] E. Zohar, S. Baruch, M. Shneider, S. Kenig, R. Tenne, H. Daniel, Journal of Adhesion Science and The Effect of WS2 Nanotubes on the Properties of Epoxy-Based Nanocomposites, (2012) 1603-1617. https://doi.org/10.1163/016942410X524138.
[16] E. Zohar, S. Baruch, M. Shneider, H. Dodiuk, S. Kenig, H. Wagner, a Zak, L. Rapoport, R. Tenne, The Mechanical and Tribological Properties of Epoxy Nanocomposites with WS2 Nanotubes, Sens. Transducer J. 12 (2011) 53-65. http://www.researchgate.net/publication/233905346_201_Sensors_Transd Epoxy_INT_Tenne-Zak/file/79e4150cb577bdc176.pdf.
[17] G. Otorgust, H. Dodiuk, S. Kenig, R. Tenne, Important insights into polyurethane nanocomposite-adhesives; a comparative study between INT-WS 2 and CNT, Eur. Polym. J. 89 (2017) 281-300. https://doi.org/10.1016/j.eurpolymj.2017.02.027.
[18] G. Otorgust, A. Sedova, H. Dodiuk, S. Kenig, R. Tenne, Carbon and tungsten disulfide nanotubes and fullerene-like nanostructures in thermoset adhesives: A critical review, Rev. Adhes. Adhes. 3 (2015) 311-363. https://doi.org/10.7569/RAA.2015.097308.

### SUMMARY OF THE INVENTION

In some embodiments, provided herein is a photo-initiator comprising inorganic fullerene-like nanoparticles or inorganic nanotubes; wherein the inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal or a transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te.

In some embodiments, the invention provides a photo-initiator consisting essentially of inorganic fullerene-like nanoparticles, or inorganic nanotubes; wherein the inorganic fullerene-like nanoparticles or inorganic nanotubes are semiconducting represented by A₁₋ₓBₓ-chalcogenide where A is a metal or a transition metal or an alloy of metals or transition metals including at least one of the following: Mo, W, Re, Ti, Zr, Hf, Pt, Ru, Rh, In, Ga, WMo, TiW; and B (dopant) is a metal or a transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te.

In other embodiments the photo-initiator comprises WS₂ or MoS₂ nanoparticles. In other embodiments the photo-initiator comprises WS₂ or MoS₂ nanoparticles or a combination thereof.

In other embodiments, the inorganic fullerene-like nanoparticles or inorganic nanotubes are coated by a silane moiety.

In some embodiment, provided herein is a radical curable composition comprising at least one monomeric radical curable unit, and at least one photo-initiator comprising inorganic fullerene-like nanoparticles or inorganic nanotubes; wherein the inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te.

In some embodiments provided herein is a method of preparing a thermoset resin, wherein the method comprises radiation curing of at least one monomeric radical curable unit in the presence of at least one photo-initiator; wherein said at least one photo-initiator comprises inorganic fullerene-like nanoparticles or inorganic nanotubes; wherein the inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga,, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is between 0 to 0.003; and the chalcogenide is selected from the S, Se and Te; wherein the radiation curing is conducted at a wavelength up to 630 nm, preferably between 350 nm to 420 nm.

In some embodiments, provided herein is a method of preparing a thermoset resin, wherein the method comprises radiation curing of at least one monomeric radical curable unit in the presence of least one photo-initiator; wherein the radiation curing is conducted at a wavelength of between 350 nm to 420 nm.

In some embodiments provided herein is a resin comprising a thermoset polymer and inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is between 0 to 0.003; and the chalcogenide is selected from the S, Se and Te; wherein the thermoset resin was prepared by radiation curing of the corresponding monomeric unit of the polymer and the nanoparticles or nanotubes are used as photo-initiators.

In some embodiment, provided herein an ink for 3D printing, a coating, an adhesive or a matrix for fiber composites comprising the resin disclosed herein.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1: Schematic illustration of the curing system.

FIG. 2: Kinetics of the photocurring of the acryate sample (#1). The WS₂ acceleration effect is demonstrated.

FIG. 3: Results of tensile toughness test of epoxy/acrylate with various content of WS₂ fullerenes.

FIG. 4: Single Lap Shear of epoxy/acrylate with various contents of WS₂ fullerenes

FIG. 5: Single Lap Shear of epoxy/acrylate with various contents of WS₂ fullerenes

FIG. 6: Single Lap Shear of epoxy/acrylate with various contents of WS₂ nanoplatelets

FIG. 7: Impact strength of epoxy/acrylate with WS₂ fullerenes.

FIG. 8: Impact strength of epoxy/acrylate with WS₂ fullerenes and WS₂ nanoplatelets.

FIG. 9: SEM micrographs of neat epoxy/acrylate (left) and epoxy/acrylate with 0.3% WS₂ fullerenes.

FIG. 10: XPS spectra for WS₂ pure, WS₂ coated acryloxy silane and WS₂ coated epoxy silane.

FIGS. 11A, 11B WS₂ coated vinyl silane, SEM (FIG. 10A), TEM (FIG. 10B). The arrow points to the amorphous coating.

FIG. 12: EPR measurments for neat INT-WS₂.

FIG. 13: EPR Comparison between neat IF-WS₂ and neat MoS₂. It is clear that the MoS₂ is less stable and self reacts with BMPO much faster than the IF-WS₂.

FIG. 14: EPR measurements for combination of IF-WS₂ and Irgacure 819.

FIG. 15: Comparison between neat IF-WS₂ and vinyl-silane modified IF WS₂.

FIG. 16: Comparison between neat IF-WS₂ and methacryloxy-silane modified IF-WS₂.

FIG. 17A, 17B: EPR measurments for neat Comerrcial Irgacure 819 PI (FIG. 7A) and EPR measurements for combination of IF-WS₂ and Irgacure 819 in acrylate (FIG. 7B).

FIG. 18: EPR measurements vinyl-silane MoS₂ in acrylate

FIG. 19: Degree of conversion for nanocomposite acrylate with and without the addition of PI.

FIG. 20: Samples thickness of acrylate resins after irradiation under UV-Led (top) with photoinitiator in addition to WS₂, (bottom) only with WS₂.

FIG. 21: depicts the components of acrylate resin formulation.

FIG. 22: shows the degree of conversion over time for neat MoS₂ for different weight percentages.

FIG. 23: shows the degree of conversion over time for vinyl MoS₂ for different weight percentages.

FIG. 24: shows the degree of conversion over time for methacryloxy MoS₂ for different weight percentages.

FIG. 25: shows a comparison of the degree of conversion over time for different moieties at 0.5% weight percentage.

FIG. 26: shows the storage modulus for 0.5 wt. % of MoS₂ and WS₂ for different moieties.

FIG. 27: Surface modification of MoS₂ with vinyl silane. FIG. 27B shows a transition electron microscope (TEM) image showing an amorphous layer coating the surface of MoS₂. FIG. 27A shows energy-dispersive X-ray spectroscopy (EDS) mapping which exhibits a thin layer of silicon atoms around the surface.

FIG. 28: Surface modification of MoS₂ with acryloxy silane. FIG. 28B shows a transition electron microscope (TEM) image showing an amorphic layer coating the surface of MoS₂. FIG. 28A shows energy-dispersive X-ray spectroscopy (EDS) mapping which exhibits a thin layer of silicon atoms around the surface.

FIG. 29: shows the lap-shear strength for 0.5 wt. % MoS₂ versus WS₂ for various moieties.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

### Photo-Initiator

In some embodiments, provided herein a photo-initiator comprising inorganic fullerene-like nanoparticles or inorganic nanotubes; wherein the inorganic fullerene-like nanoparticles, or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te.

In some embodiments, provided herein a photo-initiator consisting essentially of inorganic fullerene-like nanoparticles or inorganic nanotubes; wherein the inorganic fullerene-like nanoparticles, or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te

In another embodiment the photo-initiator is a photo-radical-initiator.

Being a semiconductor, nanoparticles exhibit high absorbance in UV/near-visible light. For example WS₂ shows an indirect bandgap of 1.3 eV and a direct gap of 2.05 eV. The absorption is characterized by two excitonic transitions, i.e. the A exciton at 625-630 nm (2 eV) and the B exciton at 520 nm (2.24 eV). Exposure of the nanoparticles to light of appropriate wavelength results in an enabling photovoltaic effect where the absorption of light produces holes and electrons, which are separated by the built-in electric field of the nanoparticle. Hydroxyl or superoxide (O₂·) radicals (oxidation) and H⁺ ions (oxidation) are generated at the semiconductor surface in contact with moisture. These free radicals are highly reactive and surprisingly accelerate polymer curing.

Inorganic Fullerene-like (IF) nanoparticles and/or inorganic nanotubes (INT) of this invention is a semiconducting represented by each having the formula A₁₋ₓBₓ-chalcognide wherein A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te. In some embodiments, the inorganic fullerene-like nanoparticles, or inorganic nanotubes inorganic nanotubes (INT) is inorganic nanoplatelets. In some embodiments, the inorganic fullerene-like nanoparticles, or inorganic nanotubes inorganic nanotubes (INT) comprises inorganic nanoplatelets.

For example, doped IF-NP or doped INT of the invention may be IF-Mo₁₋ₓReₓS₂, INT-INT-Mo₁₋ₓReₓS₂, IF-W₁₋ₓ ReₓS₂, INT-W₁₋xRexS₂ or the alloys of WMoS₂, WMoSe₂, TiWS₂, TiWSe₂, where Re is doped therein. In one embodiment, the rhenium atom serves as a dopant in the lattice of the IF-NPs/INTs. The dopants substitute for the molybdenum or tungsten atoms, which lead to an excess of negative charge carriers being trapped on the IF-NPs/INT surfaces.

In other embodiments, the concentration of the dopants is below or equal to 0.3 at %. In other embodiments, the concentration of the dopants is between 0.01 to 0.1 at %. In other embodiments, the concentration of the dopants is between 0.01 to 0.07 at %. In other embodiments, the concentration of the dopants is between 0.01 to 0.05 at %.

The doped IF-nanoparticles/inorganic nanotubes behave like charged colloids, which do not agglomerate and form stable suspensions in oils and various fluids. Additionally, the doped IF-NPs and doped INTs have higher conductivity, higher carrier density, lower activation energy, and lower resistance than the undoped ones.

In some embodiments, provided herein a photo-initiator comprising inorganic fullerene-like nanoparticles or inorganic nanotubes; wherein the inorganic fullerene-like nanoparticles, or inorganic nanotubes is WS₂. In other embodiments, the inorganic fullerene-like nanoparticles or inorganic nanotubes is of MoS₂. In one embodiment, the MoS₂ and WS₂ nanoparticles are spherical or platelet. In other embodiments, the nanoparticle is spherical having a diameter between 60-200 nm. In other embodiments, the nanoparticle is spherical having a diameter between 60-100 nm. In other embodiments, the nanoparticle is spherical having a diameter between 100-150 nm. In other embodiments, the nanoparticle is spherical having a diameter between 100-200 nm. In other embodiments between 70-100 nm. In other embodiments between 80-100 nm. In other embodiments, the nanoparticle is a platelet having a diameter of between 60-100 nm. In other embodiments a diameter between 70-100 nm. In other embodiments a diameter between 80-100 nm.

In some embodiments, provided herein a photo-initiator comprising inorganic fullerene-like nanoparticles, or inorganic nanotubes; wherein the inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te; wherein the inorganic fullerene-like nanoparticles or inorganic nanotubes are coated by a silane moiety. In other embodiments, the nanoparticle is WS₂.

In some embodiments, provided herein a photo-initiator consisting essentially of inorganic fullerene-like nanoparticles, or inorganic nanotubes; wherein the inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te; wherein the inorganic fullerene-like nanoparticles or inorganic nanotubes are coated by a silane moiety. In other embodiments, the nanoparticle is WS₂ or MOS₂. In other embodiments, the nanoparticle is WS₂ or MoS₂ or a combination thereof.

In other embodiments, the silane moiety is covalently attached to the nanoparticles or nanotubes. In some embodiments, the photo-initiator comprising inorganic fullerene-like nanoparticles, or inorganic nanotubes provided herein are coated by a silane moiety having a coating thickness of below 5 nm. In other embodiments, the silane moiety coating thickness is between 1-3 nm. In other embodiments, the silane moiety coating thickness is about 1 nm, 2 nm, 3 nm, 4 nm or 5 nm.

In other embodiments, the silane moiety is selected from 3-(methacryloyloxy) propyltrimethoxysilane, (3-glycidyloxypropyl) trimethoxysilane, vinyltrimethoxysilane, and 3-aminopropy(triethoxy) silane or any other silane known in the art. In embodiments throughout these silanes are referred to in short-hand. For example: 3-(methacryloyloxy) propyltrimethoxysilane is also referred to as methacryloxy. In some embodiments the methacryloxyl functional group is referred to as the methacryloyl group. In some embodiments vinyltrimethoxysilane is referred to as vinyl. Commonly, silanes are simply referred to by their functional group. Examples of functional groups include: vinyl, methacryloxy, amino, methoxy, ethoxy, propyl, isocyanato, chloro, bromo, mercapto, fluoro, epoxy, cyano, methyl and phenyl.

Examples of silanes known in the art include any of the following: APTES, APTMS, TMCS, HMDS, VTES, MEMS, MPS, GLYMO, KBM-403, KBM-602, KBM-603, MPTMS, GPMS, APTMSO, APTDMS, BTSE, TESPT, KH570, KH560, KH550, MTES, PEG-Silane, PPTS, TMSI, TMSE, MMS, OCTS, TES, and TMS or any combinations thereof.

### Composition

In some embodiments provided herein a radical-curable composition comprising at least one monomeric radical curable unit, and at least one photo-initiator wherein the photo-initiator comprises inorganic fullerene-like nanoparticles or inorganic nanotubes; wherein the inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te.

In some embodiments, provided herein a radical-curable composition comprising at least one monomeric radical curable unit, and at least one photo-initiator wherein the photo-initiator comprises inorganic fullerene-like nanoparticles or inorganic nanotubes having the following formula: A₁₋ₓBₓ-chalcogenide, wherein A, B, x and the chalcogenide are as described above; wherein the photo-initiator is in an amount of between 0.3% and 1% by weight of the composition. In other embodiment, the photo-initiator is in an amount of between 0.3% and 0.5% by weight of the composition. In other embodiment, the photo-initiator is in an amount of between 0.4% and 0.7% by weight of the composition. In other embodiment, the photo-initiator is in an amount of 0.3%, 0.4%, 0.5%, 0.6%, 0.7%, 0.8%, 0.9% or 1% by weight of the composition. In other embodiments, the photo-initiator is WS₂. In other embodiments, the photo-initiator is MoS₂. In other embodiments, the composition is cured by UV radiation at a wavelength below 630 nm to obtain a polymeric thermoset resin. In other embodiments the composition is cured by UV radiation at a wavelength of between 350 nm and 420 nm to obtain a polymeric thermoset resin. In other embodiments, the composition is cured by UV radiation at a wavelength 350 nm, 360 nm, 370 nm, 380 nm, 390 nm, 400 nm, 410 nm, 420 nm or any ranges thereof to obtain a polymeric thermoset resin.

In some embodiments photocuring occurs under exposure to wavelengths between 350 to 700 nm. In some embodiments photocuring occurs under exposure to wavelengths between 350 to 450 nm. In some embodiments photocuring occurs under exposure to wavelengths between 450 to 550 nm. In some embodiments photocuring occurs under exposure to wavelengths between 550 to 650 nm. In some embodiments photocuring occurs under exposure to wavelengths between 650 to 700 nm. In one embodiment the photocuring occurs under exposure to UV light. In one embodiment the photocuring occurs under exposure to white light. In one embodiment the photocuring occurs under exposure to infrared light. For example, WS₂ and MoS₂ both have absorption spectra which absorb at least up to about 650 nm wherein photocuring can occur at all wavelengths within the range of absorption.

In one embodiment the light source for illumination for photocuring is selected from: incandescent bulb, fluorescent tubes, light emitting diode (LEDs), fiber optic illuminators, vapor lamps (e.g., sodium, mercury, etc.), UV-light source, UV LED lamps, laser, laser diodes, metal halide lamps, IR-light source, IR LEDs, IR halogen lamps, IR laser diodes and IR heaters or any combinations thereof. The light source for illumination during photocuring can also comprise ambient light e.g., from the sun (daylight). In some embodiments photocuring processes further comprises heating.

In some embodiments, provided herein a radical-curable-curable composition comprising at least one monomeric radical curable unit, and at least one photo-initiator wherein the photo-initiator comprises inorganic fullerene-like nanoparticles, or inorganic nanotubes having the following formula: A₁₋ₓBₓ-chalcogenide, wherein A, B, x and the chalcogenide are as described above, wherein the monomeric radical curable unit comprises an acrylate. In other embodiments, the monomeric radical curable unit comprises methacrylate, diacrylate, epoxy acrylate, methyl acrylate or combination thereof. In other embodiments the monomeric radical curable unit is selected from the group consisting of 2-ethylphenoxy methacrylate, 2-ethylphenoxy acrylate, 2-ethylthiophenyl methacrylate, 2-ethylthiophenyl acrylate, 2-ethylaminophenyl methacrylate, 2-ethylaminophenyl acrylate, phenyl methacrylate, benzyl methacrylate, 2-phenylethyl methacrylate, 3-phenylpropyl methacrylate, 4-phenylbutyl methacrylate, 4-methylphenyl methacrylate, 4-methylbenzyl methacrylate, 2,2-methylphenylethyl methacrylate, 2,3-methylphenylethyl methacrylate, 2,4-methylphenylethyl methacrylate, 2-(4-propylphenyl)ethyl methacrylate, 2-(4-(1-methylethyl)phenyl)ethyl methacrylate, 2-(4-methoxyphenyl)ethyl methacrylate, 2-(4-cyclohexylphenyl)ethyl methacrylate, 2-(2-chlorophenyl)ethyl methacrylate, 2-(3-chlorophenyl)ethyl methacrylate, 2-(4-chlorophenyl)ethyl methacrylate, 2-(4-bromophenyl)ethyl methacrylate, 2-(3-phenylphenyl)ethyl methacrylate, 2-(4-phenylphenyl)ethyl methacrylate and 2-(4-benzylphenyl)ethyl methacrylate. In other embodiments, the monomeric radical curable unit comprises an acrylate in combination with epoxy, urethane, silicone or copolymer thereof.

In some embodiments, provided herein a radical-curable composition comprising at least one monomeric radical curable unit, and at least one photo-initiator wherein the photo-initiator comprises inorganic fullerene-like nanoparticles or inorganic nanotubes having the following formula: A₁₋ₓBₓ-chalcogenide, wherein A, B, x and the chalcogenide are as described above; and the composition further comprises an additional photo-initiator selected from aryldiazonium salt, triarylsulfonium salt and diphenyliodonium, conjugated ketones, and triazine-yl derivatives. In other embodiments, the composition is cured by UV radiation at a wavelength below 630 nm, preferably between 350 nm and 420 nm to obtain a polymeric thermoset resin.

In some embodiments, provided herein a radical-curable composition comprising at least one monomeric radical curable unit, and at least one photo-initiator wherein the photo-initiator comprises inorganic fullerene-like nanoparticles, or inorganic nanotubes having the following formula: A₁₋ₓBₓ-chalcogenide, wherein A, B, x and the chalcogenide are as described above; wherein the composition is cured by UV radiation at a wavelength of between 350 nm and 420 nm to obtain a polymeric thermoset resin, and the nanoparticles or nanotubes are homogenously dispersed within the polymeric resin.

In some embodiments, provided herein a radical-curable composition comprising at least one monomeric radical curable unit, and at least one photo-initiator wherein the photo-initiator comprises inorganic fullerene-like nanoparticles, or inorganic nanotubes having the following formula: A₁₋ₓBₓ-chalcogenide, wherein A, B, x and the chalcogenide are as described above; wherein the inorganic fullerene-like nanoparticles, or inorganic nanotubes are coated by a silane moiety. In other embodiments, the nanoparticle is WS₂. In other embodiments, the nanoparticle is MoS₂.

In other embodiments, the silane moiety is covalently attached to the nanoparticles or nanotubes. In some embodiments, the photo-initiator comprising inorganic fullerene-like nanoparticles, or inorganic nanotubes provided herein are coated by a silane moiety having a coating thickness of between less than 5 nm. In other embodiments between 0.1-5 nm, 0.1-2 nm, 1-3 nm or 2-4 nm.

In other embodiments, the silane moiety is selected from 3-(methacryloyloxy) propyltrimethoxysilane, (3-glycidyloxypropyl) trimethoxysilane, vinyltrimethoxysilane, and 3-aminopropy(triethoxy) silane, or any other silane known in the art.

The properties of composition or resins disclosed herein are affected by the nanoparticles' size, shape, and most importantly, the physio-chemical affinity to the polymer matrix. The interface controls the degree of interaction between the particles and the matrix. In some embodiments the shape of the nanoparticles is selected from: spheres, tubes, dots, rods, cuboidal, octahedral, platelets, tetrapods, frames and nanodumbells or any combination thereof. In one embodiment the nanoparticles are hollow.

Owing to the high surface area and relatively high surface energy of the nanoparticles, nanoparticles have the tendency to agglomerate. Therefore, they cannot be easily dispersed in the polymer matrix. To overcome this propensity, the surface of the nanoparticles is modified by chemical or physical means, improving thereby the interfacial adhesion with the matrix and providing their better dispersion. The hydrophilic end-group of the silane interacts chemically with the surface of the nanoparticles while the hydrophobic end interacts with the hydrophobic matrix, which enables their better dispersion. Moreover, the functional group of the silane moiety can form covalent bond with the matrix and promote the stress transfer from the matrix to the nanoparticle.

As exemplified in Example 3, surface modification of WS₂ nanoparticles (NPs) was carried-out with different types of silanes followed by incorporation of this surface modified NPs within acrylate and epoxy resins that went subsequently radical curing reaction.

The quality of the dispersion and the distribution of the nanoparticles in the nanocomposite is important for the composite/resin behavior. To benefit from the nanoparticles' properties and achieve optimal performance of the nanocomposite, it is mandatory to break the agglomerates and disperse the nanoparticles thoroughly in the matrix.

As exemplified in Examples 1 and 3, photocuring of epoxy and acrylate resins containing small amount of neat and surface-functionalized WS₂ nanoparticles led to acceleration of the photocuring process and resulted also in higher degree of the resin cross-linking. It is conjectured that the irradiated WS₂ nanoparticles absorb the irradiated light and release free radicals, which promotes the cross-linking of the polymer. In addition, adding WS₂ nanoparticles at a concentration of 0.5% wt. improved the resin mechanical properties probably due to very good dispersion of the nanoparticles in the resins by combining sonication and vortex mixing. The adhesion strength increased after the addition of the nanoparticles. As used herein and in some embodiments “neat” refers to untreated nanoparticles (of any type).

In some embodiments the nanoparticles do not comprise a hybrid. In some embodiments the nanoparticles do not consist of a hybrid. In some embodiments the nanoparticles consist of a hybrid. Examples of hybrids are: core-shell, multi-layer or Janus nanoparticles. Typically, hybrid nanoparticles comprise of two or more materials which are separated by at least one interface. In contrast, embodiments of the present invention are directed towards homogenous or monolithic nanoparticles i.e., ones wherein the nanoparticle is uniform throughout. In one embodiment the nanoparticle comprises two or more elements. As used herein and in some embodiments, the terms ‘element’ and ‘material’ are used interchangeably. However, in some embodiments, the nanoparticle comprises two or more materials. In some embodiments the two or more materials interact chemically. In other embodiments the two or more materials are separated by an interface.

### Method for the Preparation of a Resin

In some embodiments, provided herein a method preparing a thermoset resin, wherein the method comprises radical curing of at least one monomeric radical curable unit in the presence of least one photo-initiator; wherein said at least one photo-initiator comprises inorganic fullerene-like nanoparticles, or inorganic nanotubes; wherein the inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is between 0 to 0.003; and the chalcogenide is selected from the S, Se and Te; wherein the radiation curing is conducted at a wavelength of below 630 nm, preferably, between 350 nm to 420 nm.

In some embodiments, provided herein is a method of preparing a thermoset resin, wherein the method comprises radiation curing of at least one monomeric radical curable unit in the presence of least one photo-initiator, as described herein; wherein the radiation curing is conducted at a wavelength of between 350 nm to 420 nm.

It is noted that curing processes known in the art are conducted in aqueous solution (comprising water) which provide a lot of OH radicals upon illumination. In some embodiments of the present invention, the monomeric radical curable unit is comprised in a suspension. In some embodiments the suspension does not comprise water.

In other embodiments, the photo-initiator comprises WS₂ nanoparticles. In other embodiments, the photo-initiator comprises MoS₂ nanoparticles. In other embodiments, the photo-initiator comprises WS₂ and MoS₂ nanoparticles.

In some embodiments, provided herein a method preparing a thermoset resin, wherein the method comprises radiation curing of at least one monomeric radical curable unit in the presence of least one photo-initiator; wherein said at least one photo-initiator comprises inorganic fullerene-like nanoparticles or inorganic nanotubes; wherein the inorganic fullerene-like nanoparticles or inorganic nanotubes having the following formula: A₁₋ₓBₓ-chalcogenide, wherein A, B, x and the chalcogenide are as described above; wherein the inorganic fullerene-like nanoparticles or inorganic nanotubes are coated by a silane moiety.

In other embodiments, the silane moiety is covalently attached to the nanoparticles or nanotubes and the hydrophobic end of the silane moiety interacts covalently with resin/matrix.

In other embodiments, the silane moiety is selected from 3-(methacryloyloxy) propyltrimethoxysilane, (3-glycidyloxypropyl) trimethoxysilane, vinyltrimethoxysilane, and 3-aminopropy(triethoxy) silane or any other silane known in the art. In other embodiments, a silane coating layer is formed on the nanoparticle or nanotube having a thickness of less than 5 nm. In other embodiments between 0.1-5 nm, 0.1-2 nm, 1-3 nm or 2-4 nm.

In some embodiments, provided herein a method preparing a thermoset resin, wherein the method comprises radical curing of at least one monomeric radical curable unit in the presence of least one photo-initiator; wherein said at least one photo-initiator comprises inorganic fullerene-like nanoparticles, or inorganic nanotubes; wherein the inorganic fullerene-like nanoparticles or inorganic nanotubes having the following formula: A₁₋ₓBₓ-chalcogenide, wherein A, B, x and the chalcogenide are as described above, wherein the photo-initiator is in an amount of between 0.3% and 1% by weight of the composition. In other embodiment, the photo-initiator is in an amount of between 0.3% and 0.5% by weight of the composition. In other embodiment, the photo-initiator is in an amount of between 0.4% and 0.7% by weight of the composition. In other embodiment, the photo-initiator is in an amount of 0.3%, 0.4%, 0.5%, 0.6%, 0.7%, 0.8%, 0.9% or 1% by weight of the composition. In other embodiments, the photo-initiator is WS₂. In other embodiments, the photo-initiator is MoS₂.

In other embodiments, the composition is cured by UV radiation at a wavelength of below 630 nm to obtain a polymeric thermoset resin. In other embodiments, the composition is cured by UV radiation at a wavelength of between 350 nm and 630 nm to obtain a polymeric thermoset resin. In other embodiments, the composition is cured by UV radiation at a wavelength of between 350 nm and 420 nm to obtain a polymeric thermoset resin. In other embodiments, the composition is cured by UV radiation at a wavelength 350 nm, 360 nm, 370 nm, 380 nm, 390 nm, 400 nm, 410 nm, 420 nm or any ranges thereof to obtain a polymeric thermoset resin.

In some embodiments, provided herein a method preparing a thermoset resin, wherein the method comprises radical curing of at least one monomeric radical curable unit in the presence of least one photo-initiator; wherein said at least one photo-initiator comprises inorganic fullerene-like nanoparticles or inorganic nanotubes; wherein the inorganic fullerene-like nanoparticles or inorganic nanotubes having the following formula: A₁₋ₓBₓ-chalcogenide, wherein A, B, x and the chalcogenide are as described above, wherein the monomeric radical curable unit comprises an acrylate. In other embodiments the monomeric radical curable unit comprises a methacrylate, diacrylate, epoxy acrylate, methyl acrylate or combination thereof. In other embodiments, the monomeric radical curable unit is selected from the group consisting of 2-ethylphenoxy methacrylate, 2-ethylphenoxy acrylate, 2-ethylthiophenyl methacrylate, 2-ethylthiophenyl acrylate, 2-ethylaminophenyl methacrylate, 2-ethylaminophenyl acrylate, phenyl methacrylate, benzyl methacrylate, 2-phenylethyl methacrylate, 3-phenylpropyl methacrylate, 4-phenylbutyl methacrylate, 4-methylphenyl methacrylate, 4-methylbenzyl methacrylate, 2,2-methylphenylethyl methacrylate, 2,3-methylphenylethyl methacrylate, 2,4-methylphenylethyl methacrylate, 2-(4-propylphenyl)ethyl methacrylate, 2-(4-(1-methylethyl)phenyl)ethyl methacrylate, 2-(4-methoxyphenyl)ethyl methacrylate, 2-(4-cyclohexylphenyl)ethyl methacrylate, 2-(2-chlorophenyl)ethyl methacrylate, 2-(3-chlorophenyl)ethyl methacrylate, 2-(4-chlorophenyl)ethyl methacrylate, 2-(4-bromophenyl)ethyl methacrylate, 2-(3-phenylphenyl)ethyl methacrylate, 2-(4-phenylphenyl)ethyl methacrylate and 2-(4-benzylphenyl)ethyl methacrylate. In other embodiments the monomeric radical curable unit comprises an acrylate in combination with epoxy, urethane, silicone or copolymer thereof.

In some embodiments, provided herein a method preparing a thermoset resin, wherein the method comprises radical curing of at least one monomeric radical curable unit in the presence of least one photo-initiator; wherein said at least one photo-initiator comprises inorganic fullerene-like nanoparticles or inorganic nanotubes; wherein the inorganic fullerene-like nanoparticles or inorganic nanotubes having the following formula: A₁₋ₓBₓ-chalcogenide, wherein A, B, x and the chalcogenide are as described above; wherein the composition further comprises an additional initiator (radical thermal, or cationic initiator) selected from aryldiazonium salt, triarylsulfonium salt and diphenyliodonium, conjugated ketones, and triazine-yl derivatives. In other embodiments, the additional initiator radical thermal, or cationic initiator) is in an amount of between 0.1 wt % to 5 wt % of the curable monomeric unit.

In some embodiments, the method of preparing a resin provided herein comprises mixing the photo initiator and the at least one monomeric radical curable unit, optionally by sonication and/or vortex mixing.

In some embodiments, the method of preparing a resin provided herein comprises homogenously dispersed nanoparticles or nanotubes within the polymeric resin.

In some embodiments, provided herein a method preparing a thermoset resin, wherein the method comprises radical curing of at least one monomeric radical curable unit in the presence of least one photo-initiator; wherein said at least one photo-initiator comprises inorganic fullerene-like nanoparticles, or inorganic nanotubes; wherein the inorganic fullerene-like nanoparticles or inorganic nanotubes having the following formula: A₁₋ₓBₓ-chalcogenide, wherein A, B, x and the chalcogenide are as described above, wherein the radiation curing is conducted at a wavelength of between 350 nm to 420 nm and the degree of conversion (DC) is above 80%.

In other embodiments, the radiation radical curing of monomeric acrylate using the methods of this invention provided a degree of conversion of above 80% conversion. In other embodiments, a degree of conversion between 80% and 95% conversion. In other embodiments a degree of conversion between 85% and 95% conversion. In other embodiments, the radiation radical curing of monomeric acrylate provided a degree of conversion of above 90% conversion. In other embodiments, a degree of conversion between 90% and 100% conversion. In other embodiments, a degree of conversion between 92% and 100% conversion. In other embodiments, a degree of conversion between 95% and 100% conversion.

In other embodiments, the photo-initiator comprising the nanoparticles or nanotubes provided herein accelerates the curing of the monomeric radical curable unit compared to a curing without the nanoparticles or nanotubes.

In some embodiments, the method provided herein for the preparation of a cured resin comprises a resin possessing an improved adhesion by 30 to 100%, increased tensile toughness by 15%-30%, improvement in impact strength by 70%-90%, reduction of viscosity of the obtained resin by five to ten times; compared to a resin that does not comprise the nanoparticles or nanotubes.

In some embodiments the obtained cured resin possesses improved adhesion by 30 to 100%, increased tensile toughness by 15%-30%, improvement in impact strength by 70%-90%, or fracture toughness and reduction of viscosity of the obtained resin by five to ten times; compared to a resin that does not comprise the nanoparticles or nanotubes.

In some embodiments, provided herein is a resin comprising a thermoset polymer and an inorganic fullerene-like nanoparticles or inorganic nanotubes, wherein the inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal transition metal selected from the following: W, Mo, Sc, Y, La, Hf, Ir, Mn, Ru, Re, Os, V, Au, Rh, Pd, Cr, Co, Fe, Ni; x is between 0 to 0.003; and the chalcogenide is selected from the S, Se and Te; wherein the thermoset resin was prepared by radical curing of the corresponding monomeric unit of the polymer and the nanoparticles or nanotubes are used as photo-initiators.

In some embodiment, provided herein an ink for 3D printing, a coating, an adhesive or a matrix for fiber composites comprising the resin provided herein.

The following examples are presented in order to more fully illustrate the preferred embodiments of the invention. They should in no way be construed, however, as limiting the broad scope of the invention.

### EXAMPLES

### Example 1

### Dispersion and Curing of the Surface Treated Tungsten Disulfide Nanoparticles Within Thermoset Resins (Including Acrylates and Epoxy/Acrylate Resins)

### Materials:

The following thermoset resins were prepared:
#1. Acrylate resin photocured in radical reaction. The resin was based on a blend of 70% isobornyl methacrylate (IBMA) and isobomyl acrylate (IBOA), and 30 wt. % urethane diacrylate (Ebecryl 230), photoinitiator (irgacure 819).
#2. The second resin is epoxy photocured according to a cationic polymerization mechanism. The resin is based on 77% aliphatic epoxy, 23% linear polyester diol (Capa 2043). photoinitiator (speedcure 976), and nano-silica (AEROSIL R-972). These resins were supplied by CollTech (Germany) and are cured by a light source with 345-385 nm wavelength.
#3. The third resin is a combination of epoxy/acrylate (=EPGnTA) The generic formulation of this resin is aliphatic epoxy (45-50 wt. %), methyl acrylate (8-10 wt. %), epoxy acrylate (15-18 wt. %), polyester polyol (15-18 wt. %), fumed nano-silica (4-6 wt. %), and photoinitiator blend of sulfonium-based cationic photo-initiator (PI) and radical PI (3-5 wt. %). These resins were cured in 395 nm wavelength irradiation. These resins were supplied by Polymer G (Israel) and are cured by a light source with 345-385 nm wavelength.

The surface modified WS₂ NP described in Example 4 below were used.

The dispersion of the surface modified WS₂ NPs in different resin matrices was carried-out with microtip sonication (Q700, Qsonica L.L.C, Newtown, CT, USA) and a vortex mixer at 2400-3000 rpm (Wizard IR Infrared Vortex Mixer, VELP Scientifica, Usmate, Italy). The mixing of the composite was carried-out for an hour to achieve a homogenous dispersion of the nanoparticles. First, the uniformity of the film and the distribution of the NPs was examined by an optical microscope (Axioplan-ZEISS, West Germany) with ×200 magnification.

To examine the dispersion of the nanoparticles on a microscopic scale, EDS analysis was performed of a fractured surfaces of the nanocomposite. For this purpose, a specimen of the epoxy/acrylate (#3) with 0.5 wt. % WS₂ nanoparticles functionalized with vinyltrimethoxysilane was used. The film was dipped into liquid N₂ dewar for 10 min and subsequently fractured mechanically. A thin (4 nm) iridium coating was evaporated on the sample to increase the surface conductivity of the film.

### Radiation Curing System

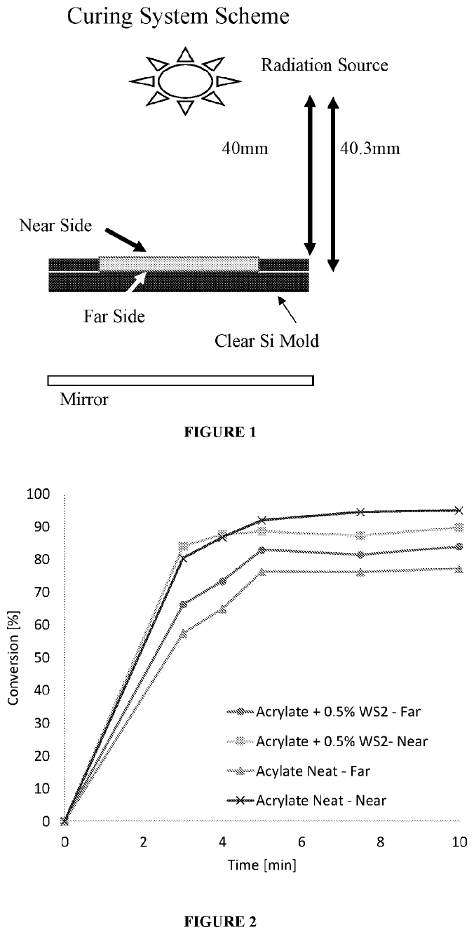

Curing was done via 395 nm wavelength LED irradiation. Curing of all samples, excluding the shear specimens, were done in transparent silicone mold (SORTA-Clear 40, Smooth-On, PA, USA) with specifically designed cavities covered by the same transparent silicone cover. Schematic illustration of the curing system is given in FIG. 1. The distance of the mold from the LED was ˜40 mm (near side). A reflecting mirror was placed under the specimen and affected the curing of the bottom side of the sample (rear side). The LED radiation intensity according to the technical specification is 7 W/cm².

### Kinetic Analysis of the Curing

The conversion level of the near side and the rear side was followed by FTIR (Fourier transform infrared) spectra, and the difference between the near and the rear sides were analyzed in order to analyze the masking effect. Attenuated Total Reflectance (ATR) FTIR (Bruker Alpha-T, Billerica, MA, USA) was employed to investigate the curing kinetics. Scanning ranged from wave number of 375 cm⁻¹ to 4000 cm^{-1.} The spectrum was gathered by averaging 40 scans with a resolution of 2 cm⁻¹.

The degree of conversion (DC) was calculated according to equation (1):

$$D C = 100 \times ( 1 - \frac{normalized polymer oxirane ring}{normalized monomer oxirane ring} ) \qquad ( 1 )$$

The data was normalized with respect to the fixed alkyl group peak at 2820-2960 cm⁻¹. The oxirane peak is located at 770-830 cm⁻¹. The accuracy of the degree of conversion was determined as 0.5% to 1%.

The weight fractions of WS₂ were: 0, 0.3, 0.5, 0.75 and 1 wt. %. In order to study the curing kinetics, the duration of the radiation was varied as follow: 10, 20, 30, 60 and 120 seconds. Samples dimensions were 25×6×0.3−0.4 mm.

### Results

### Curing

Attenuated total reflectance Fourier transform infrared spectroscopy (ATR-FTIR) (Bruker model Alpha-T, Billerica, MA, USA) was employed to validate the effect of the WS₂ nanoparticles (silane-coated and uncoated) on the curing kinetics of commercially available radical and cationic photo-cured resins. Wavenumber frequencies ranged from 375 cm⁻¹ to 4000 cm⁻¹. The degree of conversion was calculated by using Equation 1:

$$D C = 100 \times ( 1 - \frac{normalized polymer}{normalized monomer} ) \qquad ( 1 )$$

### Curing Kinetics—Results

An improvement in the curing time was observed for all resins after adding the WS₂ NPs to the neat resin. In addition, the curing time remained the same for resins with coated and uncoated WS₂ NPs. It can be concluded therefore, that the silane coating does not impair the acceleration effect of the curing kinetics imparted by the WS₂ NPs. Radiation times of more than 7.5 minutes were required to achieve degree of conversion of 85%. FIG. 2 demonstrates the acceleration effect in the degree of conversion achieved upon the addition of the WS₂ NPs to the acrylate resin. Both sides of the sample were examined, i.e. in proximity to the UV lamp and on the rear side. Adding the NPs to the acrylate improved the degree of conversion on the rear side of the sample, from 77% for the neat polymer up to 84%.

As for the acrylate (#1) resins, longer curing time from epoxy/acrylate is required to achieve a high degree of conversion. Here, radiation times of more than 7.5 minutes were required to achieve degree of conversion of 85%. Adding the NPs to the acrylate (#1) improved the degree of conversion on the rear side of the sample, from 77% for the neat polymer up to 84%.

As for the epoxy/acrylate (#2), the degree of conversion for all compositions reached 92% after 10 seconds of radiation. However, the epoxy/acrylate containing the WS₂ NPs continued the curing beyond this time, while the neat epoxy remained at the same level of conversion reaching almost 100% conversion after 20 sec irradiation.

### Example 2

### Mechanical and Thermal Properties of the Cured Surface Treated Tungsten Disulfide Nanoparticles Within Thermoset Resins

### Dynamic Mechanical Analysis (DMA)

A dynamic mechanical analysis (DMA Q800, TA Instruments, USA) was performed in order to determine the transition temperatures and examine the effect of the added WS₂ NPs on the thermal properties of the acrylate. The following samples were prepared and measured: 0 wt. %, 0.5 wt. % coated, and uncoated WS₂ NPs.

The following samples were prepared and measured for all three resins: 0 wt. %, 0.5 wt. % coated with silanes, and uncoated WS₂ nanoparticles. The samples for the DMA analysis were cured for: acrylate (#1) 7.5 min and, epoxy/acrylate (#2) and epoxy/acrylate (#3) 4 min. The sample's dimensions were 25×6×0.3−0.4 mm³. The samples (#1), (#2) and (#3) are the samples described in Example 1.

### DMA Results

The glass transition temperature [T_{g}] was evaluated from the maximum of tangent δ peak. The T_{g} values for all resins and compositions are displayed in Table 1. The pure acrylate (#1) is based on a mixture of IBMA, IBOA and urethane diacrylate. Here, two T_{g} values were observed at −9° C. and −43° C., which indicates that the cross-linking was not completed after the photocuring. It is likely that the light induces a very rapid cross-linking of the surface layer, while the bulk of the film beneath the surface the acrylate is not fully polymerized. Therefore, the T_{g} peak is either very broad in this case or simply split into two peaks [Y. Xu, L. Yan, X. Li, H. Xu, Fabrication of transition metal dichalcogenides quantum dots based on femtosecond laser ablation, Sci. Rep. 9 (2019) 1-9.]. The peak of T_{g} at −9° C. could be related to methacrylate oligomers that have not been fully cured and remained in the sample after the photocuring. After the addition of the WS₂ nanoparticles (coated and uncoated) however, only one peak (T_{g}) was observed in the photocured acrylate film. These results support the notion of the acceleration effect of the cross-linking (FIG. 2), which occurs in the presence of the of WS₂ nanoparticles.

It can be seen from Table 1 that, for the silane treated NPs the loss modulus is higher than that of a neat acrylate with untreated WS₂ NPs. The coating of the vinyl silane showed a plasticizer behavior [Atsü, Y. KeskIn, Effect of silica coating and silane surface treatment on the bond strength of soft denture liner to denture base material, J. Appl. Oral Sci. 21 (2013) 300-306.]. Indeed, for acrylate film containing WS₂ NPs with this coating, the lowest T_{g} (−51° C.) was obtained and the highest loss modulus compared to all other photocured acrylate films. Potentially, the double bond of the vinyl silane and acryloxy silane allow them to participate in the radical reaction improving thereby the bonding (and mechanical energy transfer) between the acrylate and the WS₂ NPs. Apparently, the curing of the vinyl bonds interferes with the acrylate structure, producing one with a lower T_{g}.

TABLE 1
DMA, Lap shear, of Acrylate.

| | | | Storage | Storage | Loss | Loss | | |
|---|---|---|---|---|---|---|---|---|
| | Surface | | modulus | modulus | modulus | modulus | Shear | Energy |
| | modification | T_{g} | at 20° C. | at 50° C. | at 20° C. | at 50° C. | strength | to break |
| WS₂% | by silane | (° C.) | (MPa) | (MPa) | (MPa) | (MPa) | (MPa) | (J) |
| 0 | — | −9, −43 | 258 | — | 30 | — | 4 ± 0.1 | 1.6 ± 1.7 |
| 0.5 | Uncoated | −34 | 256 | 135 | 30 | 22 | 4.7 ± 0.4 | 4.1 ± 3.0 |
| 0.5 | Coated- | −31 | 577 | 299 | 57 | 47 | 3.1 ± 1.1 | 1.0 ± 0.4 |
| | acryloxy | | | | | | | |
| | silane | | | | | | | |
| 0.5 | Coated- vinyl | −51 | 1781 | 1376 | 69 | 88 | 4.2 ± 0.5 | 5.3 ± 2.0 |
| | silane | | | | | | | |

### Lap Shear Analysis

A single lap shear tests were done in order to measure the shear strength.

A clear improvement in the adhesion was observed upon the addition of the NPs to the resins. A summary of the results is presented in Table 1. The standard deviations are relatively large. This can be explained by differences in adhesive thickness, defects in the adhesive layer, such as air bubbles or agglomeration, or by uneven surface roughness of the epoxy glass reinforced adherends (FR4) sheets [G. Otorgust, H. Dodiuk, S. Kenig, R. Tenne, Important insights into polyurethane nanocomposite-adhesives; a comparative study between INT-WS 2 and CNT, Eur. Polym. J. 89 (2017) 281-300; S.K. Gupta, D.K. Shukla, D. Kaustubh Ravindra, Effect of nanoalumina in epoxy adhesive on lap shear strength and fracture toughness of aluminium joints, J. Adhes. 97 (2021) 117-139] Cohesive failure was observed for all the samples.

For acrylate with 0.5% WS₂ coated with acryloxy silane, the elongation was improved by 160% in comparison to the neat acrylate. It is assumed that the acryloxy silane has larger free volume due to the functional group's extended length. In addition, the energy of breakage was increased compared to the neat acrylate. This result of the acrylate sample with 0.5% WS₂ coated with acryloxy silane correlates well with the increase in T_{g} (obtained by DMA testing) compared to the T_{g} of neat acrylate.

### Conclusion:

Radical curing of acrylate resins containing small amount of neat and surface-functionalized WS₂ NPs were studied. Very good dispersion of the NPs in the resins was achieved by combining sonication and vortex mixing. Clear evidence in support of the surface functionalization was obtained from FTIR, TEM and XPS analyses. The adhesion strength increased after the addition of the NPs

After surface modification, the standard deviations obtained in the shear adhesion tests were lower compared to the neat resins and resins filled with pure WS₂ NPs. This observation indicates a more uniform distribution resin matrix. A synergistic effect was obtained in cases where WS₂ NPs were incorperated in mechanical properties when compared to the pure acrylate resins.

Adding the WS₂ NPs led to acceleration of the photocuring process and resulted also in higher degree of the resin cross-linking. It is conjectured that the irradiated WS₂ NPs absorb the irradiated light and release free radicals, which promotes the cross-linking of the polymer.

### Example 3

### Physical Characterization

### Materials:

WS₂ NPs from two suppliers were used: IF-WS₂ NPs (Prepared by Weizmann Institute of Science, Israel) designated here as WS₂ fullerenes. These NPs have a quasi-spherical shape with an average diameter of 80 nm and a hollow core. WS₂ nanoplatelets was purchased (M K Impex Corp, Canada). Sequential SEM and XRD results revealed these NPs were platelet NPs (nano-flakes) and not quasi-spherical like the IF NPs. The average particle size specified by the manufacturer is 90 nm (MKN-WS2-090).

The NPs were used as received and analyzed by a variety of methods as summarized in Table 2.

TABLE 2
Intrinsic properties of the WS₂ nanoparticles

| Comparison Criteria | WS₂ fullerenes | WS₂ nanoplatelets |
|---|---|---|
| Geometry (d-space according | Spherical | Platelet (2θ = |
| to XRD) | (2θ = 14.1) | 14.2) and IF |
| Diameter | 80 nm | 90 nm |
| Moisture Content | 6.7% weight | 1.5% weight |
| | loss | loss |
| pH value | 4.9 | 7.2 |
| Oxygen/Tungsten ratio by XPS | 0.55 | 0.83 |

### Tensile Tests

Special cavities were manufactured for the preparation of dog-bone samples having a thickness of 0.3-0.4 mm. The content of the NPs in the nanocomposites 0.3 to 1% by weight. The curing cycle was 300 seconds. The mechanical testing was done using a universal testing machine (Instron 4481, Grove City, PA, USA) at a loading rate of 1 mm/min.

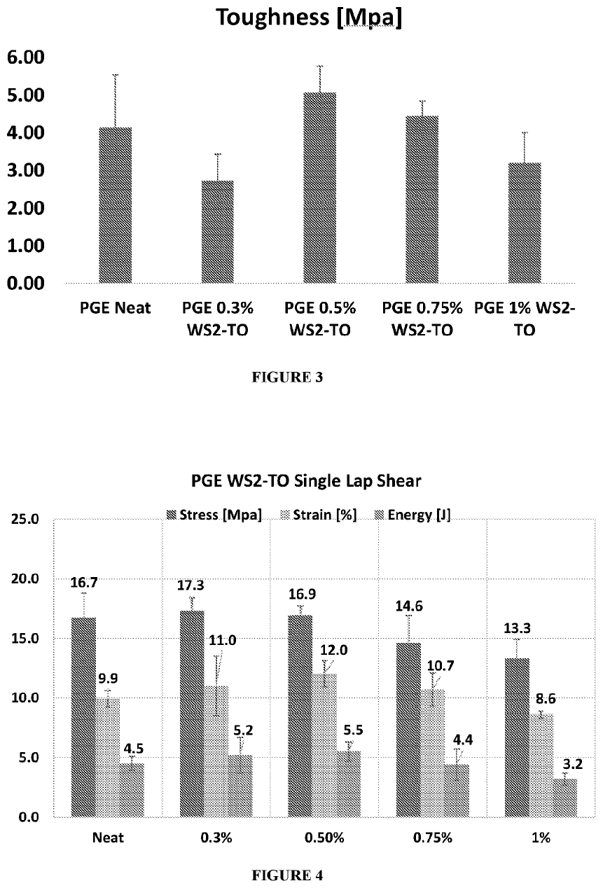

Tensile properties were measured only for epoxy/acrylate resin with WS₂. The toughness was determined from the area under the stress-strain curves. As can be seen in FIG. 3 an increase of 22% in toughness has been accomplished by incorporation of 0.5 wt. % of WS₂.

### Single Lap Shear Preparation and Characterization—Adhesion Strength

0.1-0.2 mm thickness of nanocomposite resin layer was applied and cured between two pre-cleaned (by EtOH and Acetone) glass fiber reinforced (GFR) epoxy plates (FR4). The FR4 thickness was 2 mm. This GFR material does not absorbs radiation at 395 nm, hence curing of the studied resins at this wavelength is applicable. The over-lap length was 12.6-13 mm. The GFR plate width was 25 mm. Samples were placed ˜30 mm from the LED source and cured for 18 minutes. The long curing cycle time was dictated by the absorbance of the relatively thick GFR plates. Measurement of the samples were done ˜30 minutes after curing. Mechanical loading of the specimens was done according to ASTM D1002 using loading rate of 5 mm/min. The test was employed on a universal testing machine (Instron 4481, Grove City, PA, USA).

The adhesion strength of the various compositions was investigated using lap shear type specimens. Experimental results have shown that all specimens failed in the FRP adherent, as can be seen in FIG. 4 (for epoxy/acrylate with 0.5 wt. % WS₂ fullerene).

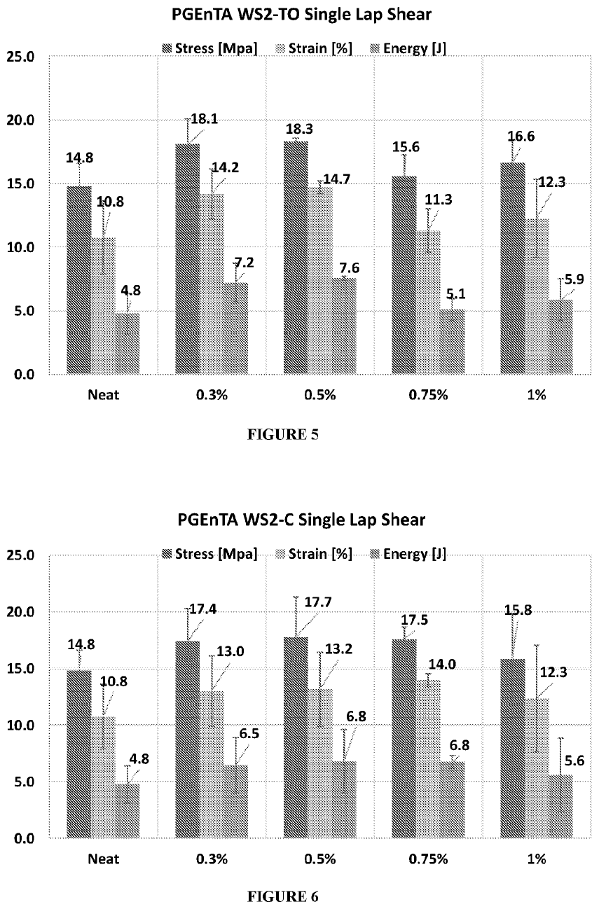

Hence, it was concluded that since the resin showed stronger adhesion to the GRP substrate, the adhesion strength of the nanocomposites adhesives could not be determined with these substrates. Nonetheless, strain to failure and energy to break were determined for the formulations studied. Results of the single lap shear specimens can be observed in FIGS. 4, 5 and 6.

As evident from the results, epoxy/acrylate (#3) attributes are higher than those of epoxy/acrylate (#2) samples for all formulations, excluding the strength values for the neat samples. A possible explanation may be attributed to slower curing kinetics of epoxy/acrylate (#3) compared to the fast curing of epoxy/acrylate (#2), which may lead to higher crosslink densities. epoxy/acrylate (#3) based NCs adhesives exhibited higher level of mixed failure for WS₂ nanoplatelets containing formulations compared to WS₂ fullerene ones. Epoxy/acrylate (#2) based compositions showed 100% cohesive failure in the adherents. Results indicated that there was no clear benefit of 0.3, 0.5 and 0.75 wt. % containing WS₂ nanoplatelets resins. All three compositions displayed superior properties compared to neat and 1% NPs containing samples. Higher variability in the results were present in NCs based on epoxy/acrylate (#3) with WS₂ nanoplatelets compared to epoxy/acrylate (#3) with WS₂-fullerene samples. This may be the result of mixed failure mechanism. Finally, epoxy/acrylate (#3) containing WS₂ fullerene at 0.3 wt. % and 0.5 wt. % concentrations showed a clear superiority of adhesion strength.

The energy at break demonstrated a 20% increase for epoxy/acrylate (2) based compositions. In the case of epoxy/acrylate (#3) a 40% increase for WS₂ nanoplatelet and 60% increase for WS₂ fullerene NPs were obtained.

### Impact Properties

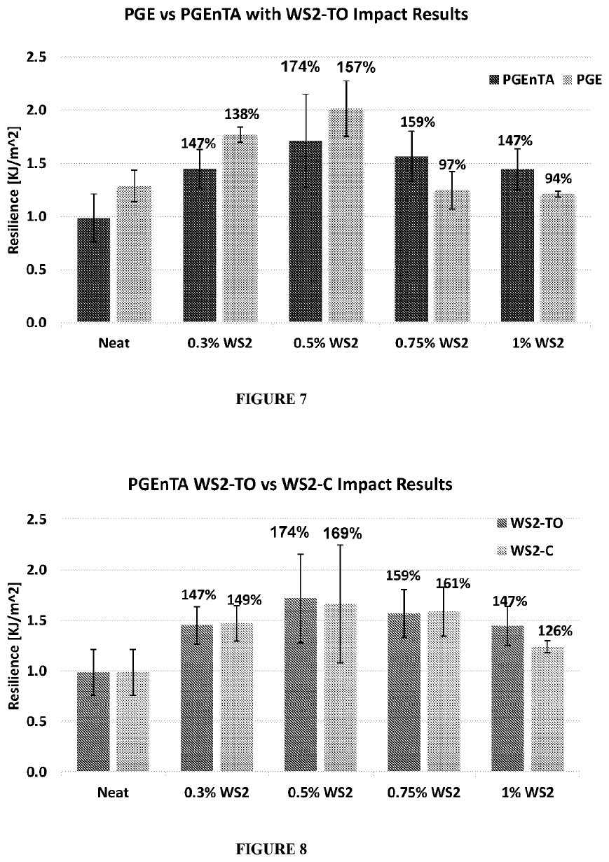

As can be seen in FIG. 7, epoxy/acrylate (#3) exhibits 25% lower impact than epoxy/acrylate (#2). This may be attributed to the TA (thermal analysis) effect on the crosslinking density of the various compositions.

Distinctively, as WS₂ fullerene content was increased above 0.5 wt. % a significant decrease in impact strength of the epoxy/acrylate (#2) formulations can be perceived, in contrast to moderate decrease for the case of epoxy/acrylate (#3) based nanocomposites (NCs). epoxy/acrylate (#3) based NCs exhibits higher impact strength for higher NPs content, in addition to higher Tg compared to epoxy/acrylate (#2) based NCs.

As can be seen in FIG. 7 and FIG. 8, best impact results have been received for 0.5% content for both WS₂ sources. Significant impact improvement of 75% for epoxy/acrylate (#3) and of 60% for epoxy/acrylate (#2) were achieved at optimal concentration of the WS₂ NPs.

### Effect of NPs Content on the Mechanical Properties

From the results obtained in tensile, impact and shear tests, it can be concluded that overall, the optimal results and improvements of 22%, 75% and 60%, respectively, are reached with 0.5 wt. % of WS₂ fullerene. Thus, one can conclude that the addition of WS₂ fullerene to the resin has beneficial effect, on the mechanical properties of the nanocomposite. Adding WS₂ nanoplatelet led to an improvement of 69% and 40% in impact and shear, respectively. Surface chemistry analysis suggests that higher oxygen content on the WS₂ platelet inhibits the NPs positive effect reached by WS₂ fullerene. The WS₂-fullerene exhibits larger interface interaction between the NPs and the resin, since its higher sulfur content leads to more readily bonding to the resin matrix.

Increasing the content of the NPs beyond this threshold, leads to reduction in the mechanical properties, even beyond the neat sample, as was evident for impact results of 0.75 wt. % and 1 wt. % of WS₂ fullerene in epoxy/acrylate (#2) (FIG. 7). This shows the complex nature of higher loadings of the WS₂ fullerene, which affects favorably the curing kinetics but is impairing the mechanical properties. Indeed, agglomeration of the NPs is often observed beyond 0.5 wt. % loading of the WS₂ fullerene NPs [M. Shneider, H. Dodiuk, S. Kenig, and R. Tenne, “The effect of tungsten sulfide fullerene-like nanoparticles on the toughness of epoxy adhesives,” J. Adhes. Sci. Technol., vol. 24, no. 6, pp. 1083-1095, 2010].

### Analysis of the Nanocomposites (NCs) Surfaces Fractured by Impact and Tensile

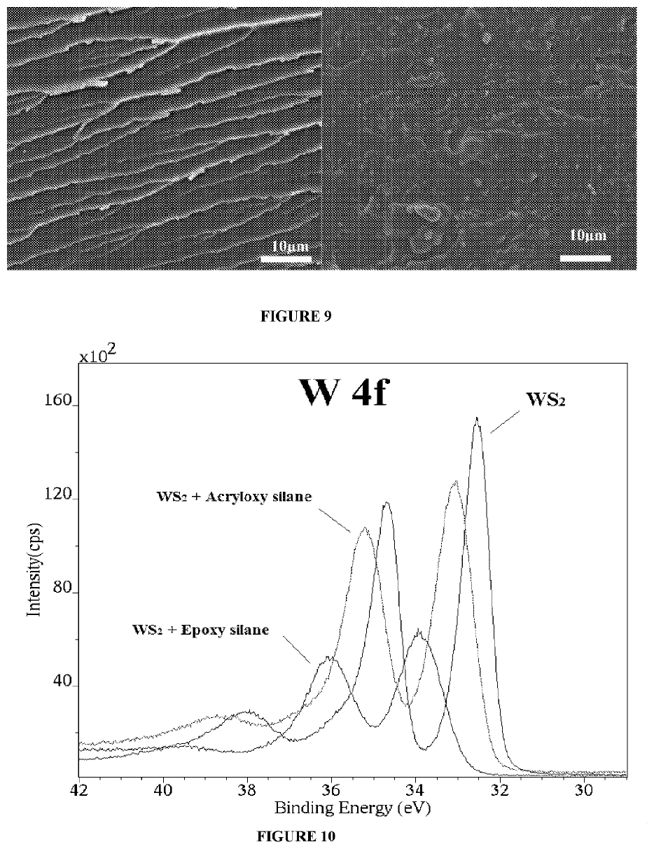

SEM analysis was used to study the fracture mechanisms and the mechanical properties of the radiation cured nanocomposites based on cationic curing of the epoxy and radical curing of the acrylate using the tri-initiator system. FIG. 9 shows the basic difference of neat and radiation cured nanocomposites systems based on epoxy/acrylate (#2).

Analysis of the results indicate that enhanced mechanical properties have been obtained when larger craters and sharper outlined borderlines were observed. The WS₂ containing formulations (in addition to the nano-silica for flow/viscosity control) reveal larger craters and hence enhanced properties. It may be postulated that the nodular boundaries could be induced during failure by crack deflection, which nucleated at the NPs. The larger craters were obtained at WS₂ concentration of 0.5 wt. %. Increasing the concentration to 1 wt. % lead to reduced crater size and reduced properties. The size of the crater is the result of the energy needed to form the crater. Hence, larger craters indicate higher level of energy dissipation. EDX analysis was carried out in order to evaluate the elemental composition of the NPs at the center of the nodules. WS₂ was found in the center of the nodules in 0.5 wt. % and 1 wt. % WS₂. In the case of neat resins craters were also noticed resulting from the nano-silica.

### Conclusions

The main effect of the WS₂ combined with the silica NPs is the substantial increase in the energy absorption during impact loading which leads to 80% and 60% increase in the shear adhesion strength compared to neat systems. SEM and AFM of fractured surfaces indicated that distinctive morphology was developed depending on the level of loading with the WS₂ NPs, supporting the mechanical test results. Tg levels were similar or higher upon WS₂ NPs incorporation. It was determined that the surface chemistry and dispersion techniques of the WS₂ NPs are the major variables affecting the bulk properties of cationic cured resins and its adhesion properties.

### Example 4

### Surface Treatments for Tungsten Disulfide Nanoparticles

### Materials:

The tungsten disulfide [WS₂] NPs were of nanoplatelet type The nanoparticles were 90 nm in size.

For the surface functionalization of the WS₂ nanoparticles (NPs), four types of silanes were used: 3-(methacryloyloxy) propyltrimethoxysilane, (3-glycidyloxypropyl) trimethoxysilane, vinyltrimethoxysilane, and 3-aminopropy(triethoxy) silane.

### Silane Functionalization

Mixture of ethanol, distilled water, and silane in a ratio of (95:5):1 was first prepared. The pH of the solution was reduced to 4.5 dropwise with acetic acid. The solution was then mixed with a magnet stirrer for 1 hour. To this solution, 1.5% of WS₂ nanoparticles (after vacuum annealing at 70° C. for 2 h) were added. The solution with the nanoparticles was mixed in a bath-sonicated (Ultrasonics, TRANSSONIC TS 540, Elma, Germany) for 2 hours. The coated WS₂ NPs were rinsed with fresh ethanol three times and dried under vacuum for 2 h at 120° C. [ M. Shneider, H. Dodiuk, R. Tenne, S. Kenig, Nanoinduced morphology and enhanced properties of epoxy containing tungsten disulfide nanoparticles, Polym. Eng. Sci. 53 (2013) 2624-2632].

The quality of the particle coating was analyzed by FTIR (ATR-FTIR model Bruker Alpha-T, Billerica, MA, USA). X-ray photoelectron spectroscopy (XPS) measurements were carried-out with Kratos AXIS ULTRA system using a monochromatic Al Kα X-ray source (hv=1486.6 eV) at 75 W and detection pass energies ranging between 20 and 80 eV. Curve fitting analysis was based on linear or Shirley background subtraction and application of Gaussian-Lorenzian line shapes. The morphology of the nanoparticles' powders was characterized by high resolution scanning electron microscope—HR-SEM (Zeiss Supera 55, Zeiss, Oberkochen, Germany), using secondary electrons (SE) detector at 10 kV. Energy dispersive X-ray spectroscopy (EDS) analysis and mapping was performed using a retractable four quadrants detector (Bruker QUANTAX FlatQUAD) which is installed on a Zeiss Ultra 55 SEM. The quantification of the elements is based on standard-less and self-calibrating spectrum analysis procedure, using the ZAF matrix correction formulas. High-resolution transmission electron microscopy—HR-TEM analysis was performed with a field-emission gun operating at 200 kV (ThermoFisher model Talos™ F200S TEM).

### FTIR Characterization

The typical IR-spectrum of WS₂ included a 870 cm⁻¹ peak typical of the S-S bond and another peak characteristic for the W-S bond at 570-625 cm⁻¹ wavenumbers. After the surface modification, the WS₂ nanoparticles were first characterized by ATR-IR. In the resulting IR spectrum, changes were observed in the IR spectra of the WS₂ nanoparticles before and after the silane surface modification. New peaks related to silane occurred for all types of treatments. The peak in 1189 cm⁻¹ is assigned to the Si-O-CH₃ vibration, while the peak in 1070-1104 cm⁻¹ is characteristic to the vibration of the Si-O-C group.

For WS₂ NPs coated with epoxy silane, a new peak at 925 cm⁻¹, compatible with the oxirane group in the silane, was observed. For WS₂ NPs coated with vinyl silane, a new peak was observed around 1400 cm⁻¹. For WS₂ NPs coated with acryloxy silane, a new peak was observed in 1704 cm ⁻¹, which was related to the vibration of a carbonyl group. For WS₂ NPs coated with amino silane, a new peak is observed in the range of 1594-1603 cm ⁻¹ matching the literature value of N-H vibration. Therefore, the IR spectra of the surface modified WS₂ nanoparticles attest to the chemical bonding obtained between the silane moieties and the NPs.

### XPS Characterization

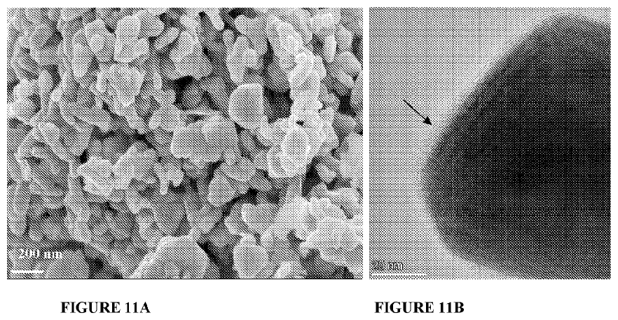

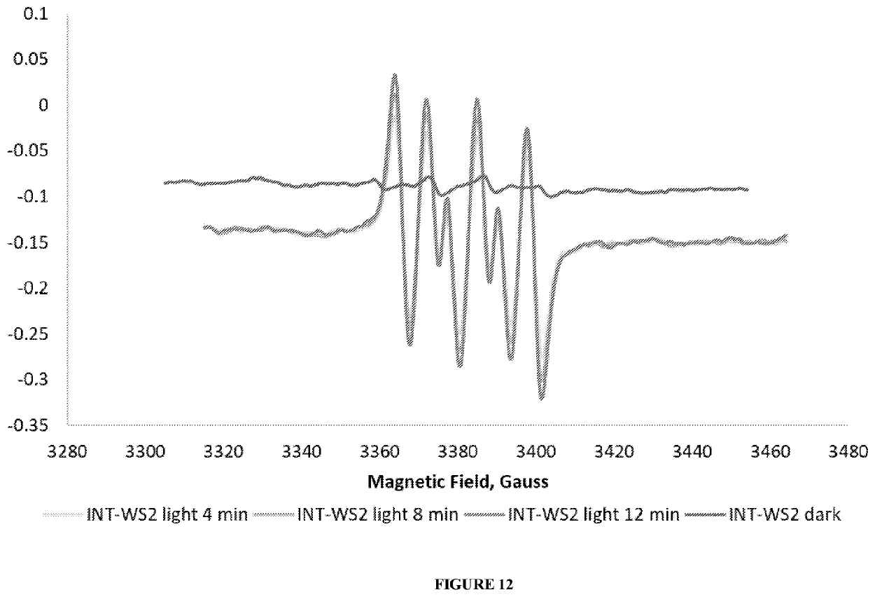

XPS analysis of the pristine and surface modified nanoparticles was performed with the purpose of verification and quantification of the covalent bonds that were formed between the WS₂ nanoparticles and the silane moieties. After the silane treatment, the W peak (FIG. 10) exhibited a blueshift, i.e. the electron density near the tungsten atom was reduced. This blueshift indicates that the silane functionalization influences the conductivity of the nanoparticles. The results of the XPS analysis are summarized in Table 3. They clearly reveal that W-O-Si bonds were indeed formed on the NPs surface. Presumably, the oxygen present on the NPs surface, undergoes condensation reaction with the silanol groups to form the W-O-Si covalent bonds. For WS₂ nanoparticles with vinyl coating, no silane bonds could be seen, because the coating created a thick insulating film, which prevented direct XPS analysis of the surface modified specimen. According to the SEM analysis, the thickness of the silane layer on the WS₂ nanoparticles obtained after the silane treatments ranged from 2.2 to 4.3 nm. For nanoparticles coated with vinyl silane, the thickness of the coating film was the largest, i.e. 4.3 nm, which may explain the impairment of the conductivity of the WS₂ nanoparticles.

TABLE 3
Atomic concentration ratios and (average) thickness of the silane
coating on the WS₂ NPs surface, derived from the XPS analysis.

| Sample/ | Sₜₒₜ/ | S_{red}/ | W_{WO3}/ | Wₒₛᵢ/ | S_{SO4}/ | S_{S—C, S—H}/ | Nₜₒₜ/ | N_{red}/ | Silane | Silane + top |
|---|---|---|---|---|---|---|---|---|---|---|
| Ratio | wₜₒₜ | w_{red} | wₜₒₜ | wₜₒₜ | Sₜₒₜ | Sₜₒₜ | Si | Si | layer, À (max) | impurities, À(max) |
| Bare | 1.88 | 2.05 | 0.13 | — | 0.05 | — | | | — | 2.9 |
| Coated - | 2.13 | — | — | — | — | — | | | 42.7 | 42.9 |
| vinyl | | | | | | | | | | |
| silane | | | | | | | | | | |
| Coated - | 2.14 | 2.18 | 0.04 | 0.06 | — | 0.09 | | | 39.4 | 39.7 |
| epoxy | | | | | | | | | | |
| silane | | | | | | | | | | |
| Coated - | 2.12 | 2.09 | 0.07 | 0.1 | 0.01 | 0.16 | 0.95 | 0.97 | 21.7 | 22.1 |
| Amino | | | | | | | | | | |
| silane | | | | | | | | | | |
| Coated - | 2.16 | 2.25 | 0.08 | 0.06 | — | 0.10 | | | 35.8 | 36.0 |
| Acrloxy | | | | | | | | | | |
| silane | | | | | | | | | | |

The (vinyl) silane coated WS₂ nanoparticles were first analyzed by SEM (FIG. 11A) and subsequnetly by TEM (FIG. 11B). The SEM analysis (FIG. 11A) of the functionalized NP shows that they remained the same and their overall shape and size was not affected by the surface treatment. TEM image (FIG. 11B), indicated that a relatively thick silane layer (4 nm) surrounded the surface functionalized nanoparticles.

### Example 5

### Radical Photo-Curing of Acrylates Characterized by Electron Paramagnetic Resonance (EPR)

In order to understand the acceleration effect of the radical photo-curing reaction of acrylate, a series of EPR measurements were performed. EPR is the most suitable and informative test in the field of free radical's formation. The main purpose was to identify free radicals' formation by WS₂ without the addition of a photo initiator.

Free radicals have short-life time. To overcome this limitation, spin trap was added to the dispersions. Spin traps are usually nitrone molecules that react with the free radicals to generate more stable nitroxide radicals. With this technique, EPR spectra of the original radicals can be obtained. For all the measurements, BMPO (5-tert-Butoxycarbonyl-5-methyl-1-pyrroline-N-oxide) have been used as spin trap.

Surface Silane Modification for IF-WS₂ and MoS₂

Surface modification for MoS₂ and WS₂ was carried out as follow: solution of ethanol and deionized water (95:5 by weight) was prepared and mixed with magnetic stirrer. 1% (by volume) of vinyl silane was added to the solution. Acetic acid was added (dropwise) until the pH of the solution dropped to 4.5. The solution was mixed for 1 h at room temperature. Pre-dried nanoparticles (NPs) of MoS₂ and WS₂ (vacuum, 2h, 70° C.) was added to the solution (1.5 wt. %). The mixture was sonicated (bath sonicator) for 2h (15 min pulses to prevent excessive heat rise). After evaporation of the solvents, the silane modified NPs were washed three times with ethanol and dried under vacuum (2h at 120° C.).

### Samples Preparation for EPR Experiments

Ethanol or neat acrylate formulations without the addition of conventional photo initiator (PI) were prepared via ultrasonication cycles combined with mechanical vortex (materials and composition are detailed in Table 4). Spin trap (BMPO) and NPs were dispersed in the medium (ethanol or acrylate) by bath sonicator (concentrations of NPs in ethanol and acrylate are detailed in Table 5).

TABLE 4
Acrylate resin composition

| | Concentration [mg/mL] | |
|---|---|---|
| NPs | Ethanol | Acrylate |
| Neat WS₂ inorganic tubes | 12.5 | 5.6 |
| Neat WS₂ fullerenes | 6 | 24 |
| Neat MoS₂ | 9.4 | 8.7 |
| Vinyl-silane treated WS₂ | 6 | 11.7 |
| Methacryloxy-silane treated WS₂ | 6 | 8 |
| Vinyl-silane treated MoS₂ flakes | 9.4 | 9.5 |
| Methacryloxy-silane treated MoS₂ flakes | 9.4 | 7.5 |
| Photoinitiator (Irgacure 819) | 5.7 | 6.6 |
| WS₂/Photoinitiator (Irgacure 819) | 11/<1 | 10.3/1.2 |

TABLE 5
Concentration of NPs in ethanol and acrylate

| Materials | wt. % |
|---|---|
| Isoboronyl methacrylate (photomer) | 70 |
| Ureathane diacrylate (Ebecryl 230) | 30 |
| Irgacure 819 (photoinitiator) | 1 |
| MEMO (Silane) | 1 |
| Silica (Aerosil R-972) | 3 |

The WS₂ nanoparticles produced superoxide radicals under illumination. Minor reaction was observed in the dark. As can be seen in FIG. 2, the inorganic nanotubes of WS₂ formed radicals in ethanol. The line shape of this EPR spectrum shows that in the dark there was small amount of radicals formed. However, upon white light illumination a large signal of superoxide radical (O₂·) was observed, which increased upon radiation time. This formation of the superoxide radical can be attributed to the photo-induced hole oxidation of water and ethanol according to the reaction:

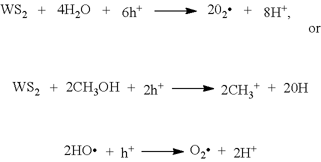

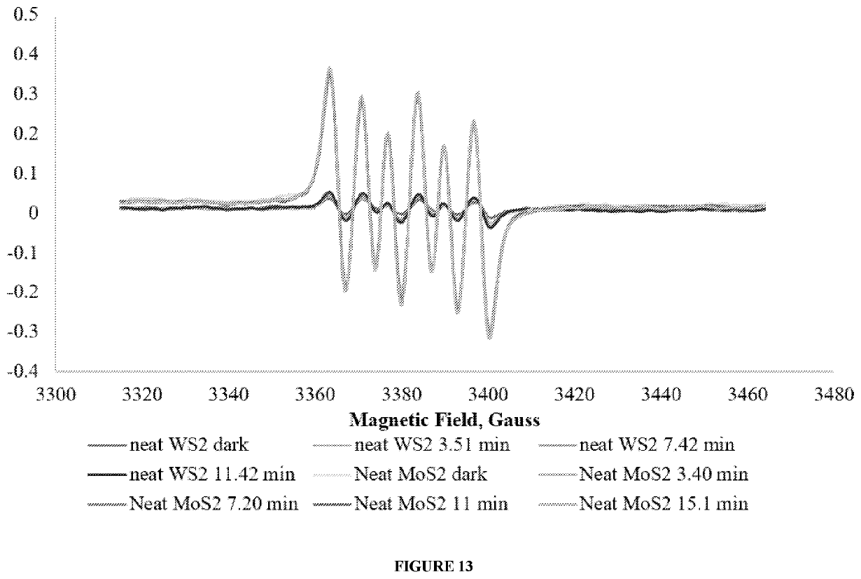

FIG. 13 presents EPR measurements of neat inorganic fullerene of WS₂ and neat MoS₂.

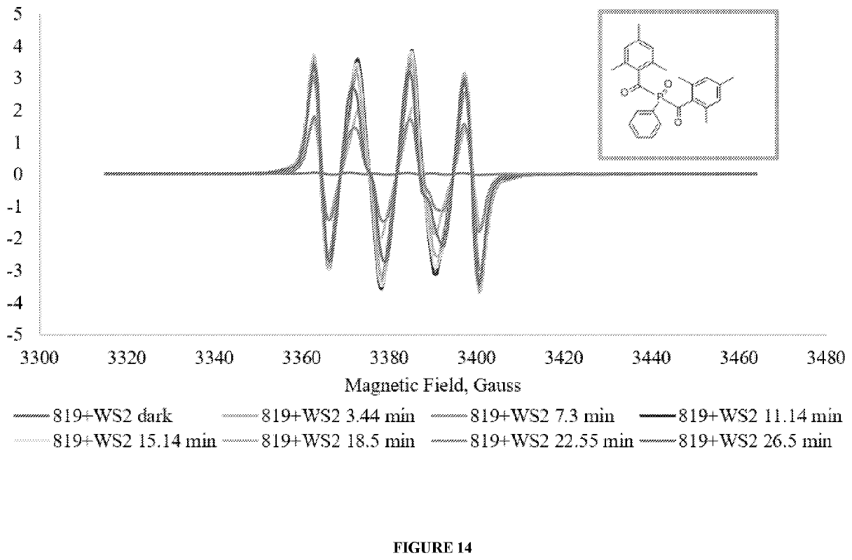

FIG. 14 presents EPR measurements of combination of WS₂ and PI (Irgacure 819). The addition of WS₂ fullerene to Irgacure 819 (FIG. 14) leads to the production of both OH and superoxide radicals. Also, when the PI is consumed the WS₂ fullerene continues to produce radicals under illumination. This shows that the WS₂ fullerene is stable and is not self consumed like the PI, and that the superoixde radicals dominate after a few minutes, i.e. there are two different mechanisms operating probably in the acrylate poymerization.

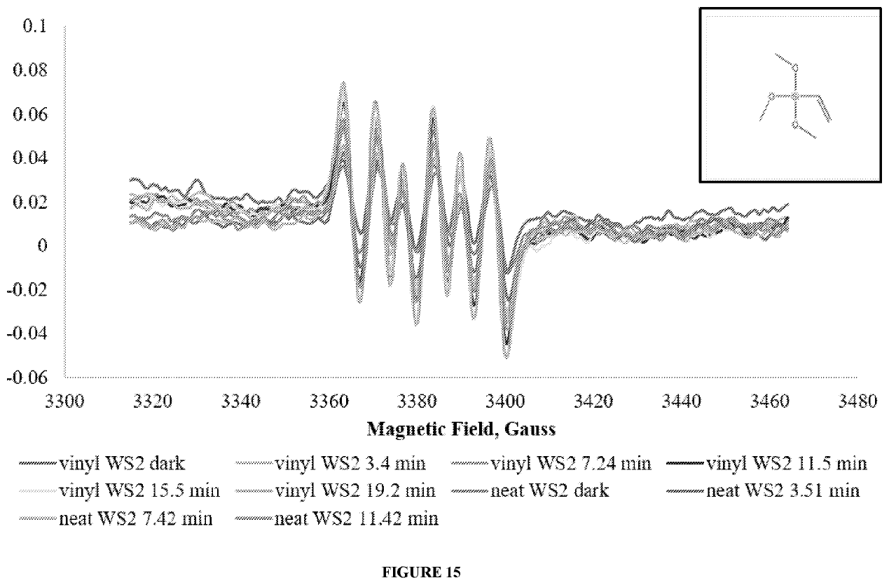

FIG. 15 presents comparison between neat WS₂ fullerene and vinyl-silane coated WS₂ fullerene, showing the same radical activity of the coated nanoparticles compared to non-coated.

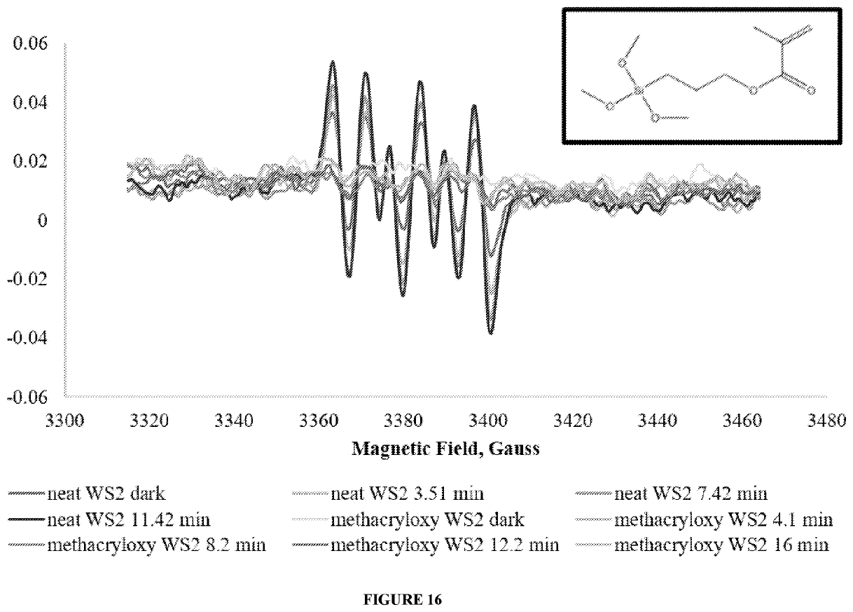

FIG. 16 presents comparison between neat WS₂ fullerene and methacryloxy-silane coated WS₂ fullerene, showing the same radical activity of the coated nanoparticles compared to non-coated.

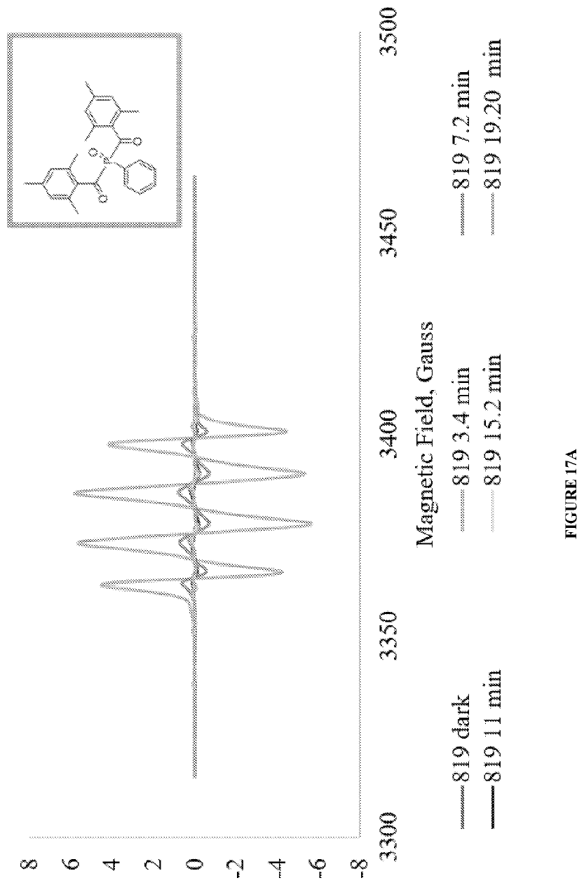

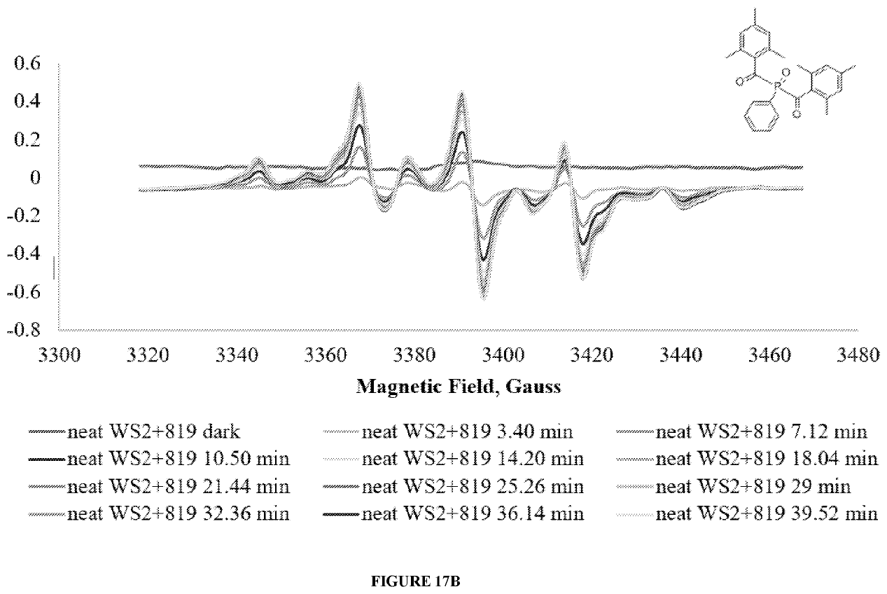

FIG. 17A and 17B present EPR measurments for neat Commercial PI (Irgacure 819) in acrylate (FIG. 17A) and EPR measurements for combination of WS₂ fullerene and PI (Irgacure 819) in acrylate (FIG. 17B) showing a different mechanism via OH radicals of the ‘819 and a superoxide mechanism of the nanoparticles.

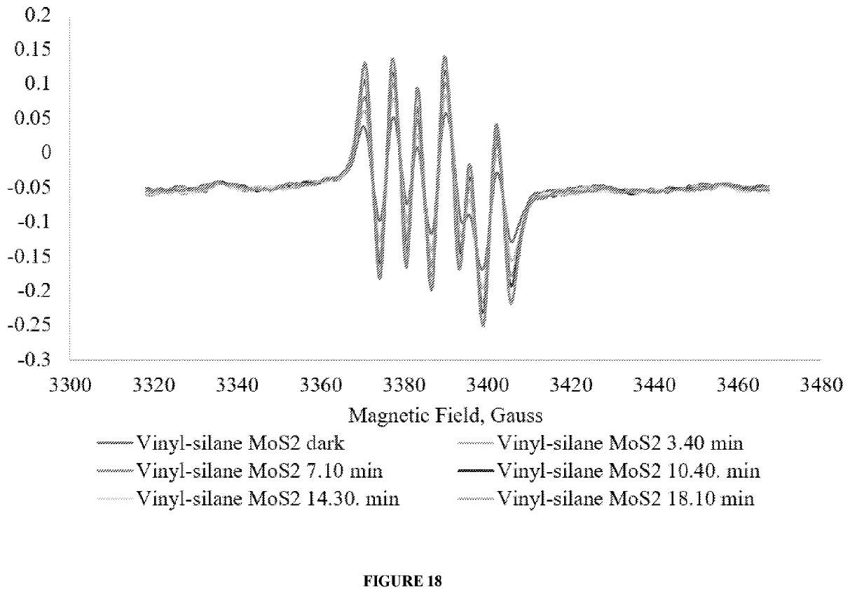

FIG. 18 presents EPR measurements vinyl-silane coated MoS₂ flakes in acrylate showing a superoxide radical mechanism.

The kinetics of radical formation under laser light illumination of the different reactants was studied.

In the case of WS₂ nanotubes and MoS₂ flakes, the initial rise in the concentration of the radical reaction product in the solution was linear with time, i.e. first order with respect to the radical concentration (light intensity). After about 5 min. irradiation, of the two reactions showed partial saturation, i.e. another linear relationship with appreciably smaller rate constant, was developed. One possible explanation is that, in this regime the linear relationship was with respect to the remainder of the spin trap (BMPO) in the solution. In this case the irradiation intensity, i.e. density of the radicals, should not play a role, which can be easily verified. In the case of the BAPO PI (Irgacure 819), the linear relationship was similar to the one observed in the second stage of the reaction of WS₂ inorganic tubes and MoS₂, i.e. the reaction rate was dictated by the availability of the BMPO spin trap. The similarity between the two reaction rates (of BAPO and WS₂ inorganic tubes after 5 min), suggests that the mechanism went from the initial superoxide radical formation-mechanism to hydroxyl radical dictated mechanism, after 5 min irradiation in the presence of inorganic tubes.

When EPR spectra was recorded in acrylate solutions containing PI (Irgacure 819), inorganic tubes and the spin trap, no EPR signal was obtained. This situation suggests that the kinetics of the radical reaction with the acrylate and the polymerization reaction were much faster than the rate constant of the reaction of the free radicals with the spin trap.

### Example 6

Curing of Nanocomposite Acrylate with WS2 Nanoparticles Without Additional Photoinitator (PI)

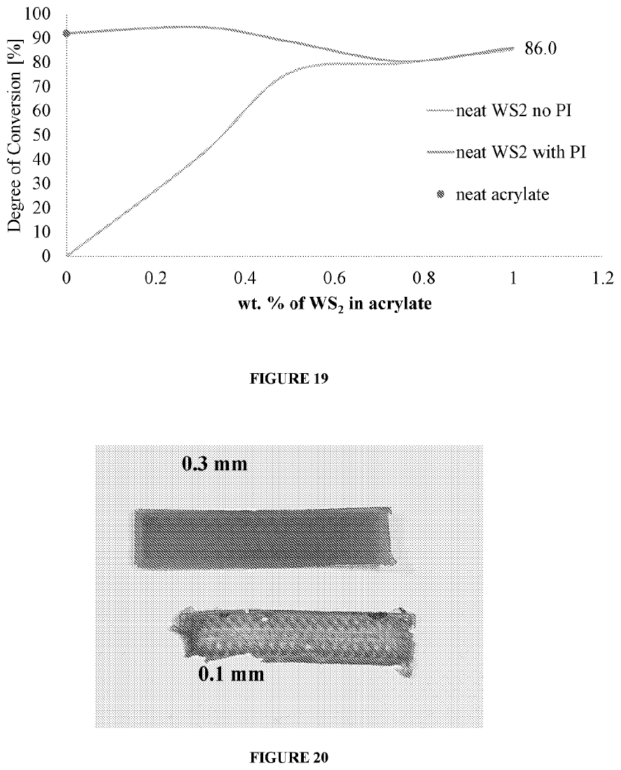

Irradiation radical curing of WS₂ nanocomposite acrylate without the addition of a photoinitiator (PI) was studied. Surprisingly, the acrylate resin was cured after the irradiation under 365 nm UV-LED without the addition of photoinitator. FIG. 19 shows the degree of conversion of WS₂ nanocomposite acrylate. The measurements were carried out as follows: Four compositions of acrylate with different loads of WS₂: 0.3, 0.5, 0.75 and, 1 wt. % were prepared without the addition of PI. For all the composition the samples were irradiated for 5 min under UV-led lamp with 365 nm wavelength. Degree of conversion was measured with ATR-FTIR with comparison to the integration of C═C double bond. The degree of conversion that was obtained for nanocomposite acrylate without PI is high (up to 86%) at 0.8 and 1.0 wt. % of WS₂. It is important to notice that the sample that were obtained is thin (0.1 mm) compared to nanocomposite acrylate with the addition of PI (0.3 mm) (FIG. 20).

### Example 7

### Acrylate Resin Formulation

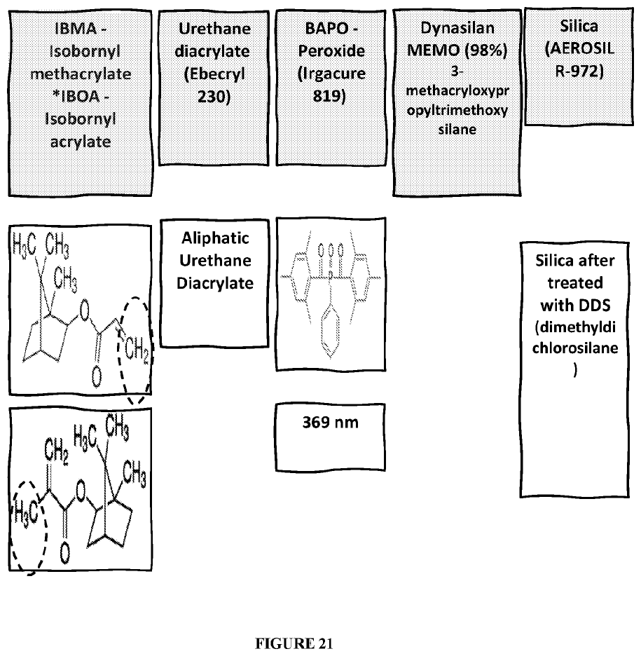

FIG. 21 show an example of the components comprised in acrylate resin formulation. Standard materials are used, as outlined in Table 5 above. Namely: isoboronyl methacrylate (photomer), ureathane diacrylate (Ebecryl 230), irgacure 819 (photoinitiator), dynasilan MEMO (3-methacryloxypropyltrimethoxy silane) and silica (Aerosil R-972). A variety of moieties (methacryloxy silane treated MoS2, vinyl silane treated MoS₂ and neat MoS₂) are used at different weight percentages: 0.3, 0.5 and 0.75 wt. % of MoS₂.

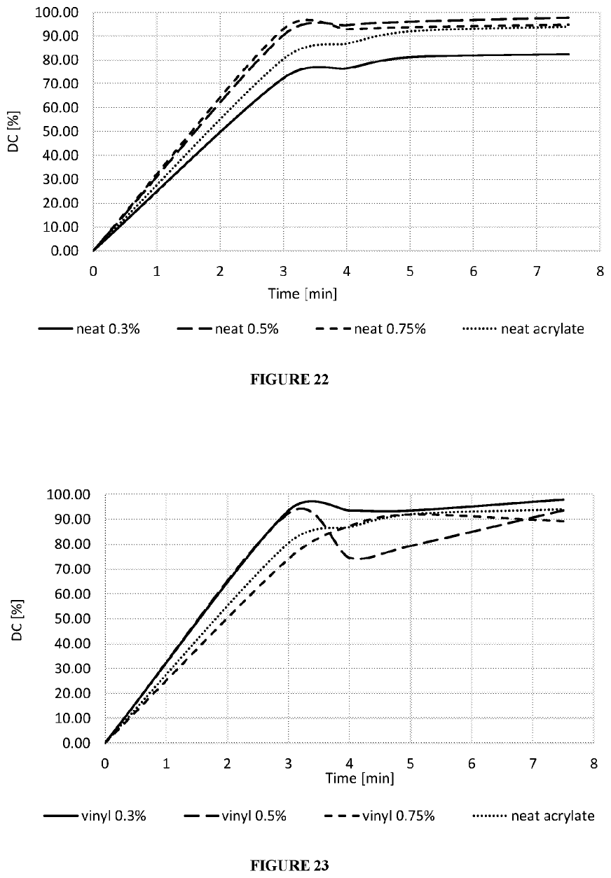

FIG. 22 shows photocuring of neat MoS₂ at different concentrations. For example at 4 mins of UV radiation for neat MoS₂ at 0.75% wt concentration the degree of conversion reached 93%. At 7.5 mins of UV radiation neat MoS₂ at 0.5% wt. concentration the degree of conversion reached 95%. As can be seen, the rate of conversion is almost linear at the beginning of treatment and then stabilizes. In should be noted that reaching maximum conversion, i.e., curing, takes between about 3 to 8 minutes. Photocuring was carried out at an exposure of about between 345 to 385 nm.

The degree of conversion was determined by Fourier transform infrared (FTIR) spectroscopy by monitoring significant peaks in the ranges 1620-1650 cm⁻¹ (C═C) and 1660-1760 cm⁻¹ (C═O). In various embodiments, other functional group peaks can be used to monitor the degree of conversion, for example: amide, amines, carbonyl, alkene, aldehydes, carboxylic, ethers, esters, etc.

FIG. 23 shows photocuring of MoS₂ with vinyl silane treatment. For concentrations between 0.3-0.5 wt. % a degree of conversion of 94-98% is reached after 7.5 mins of UV radiation curing.

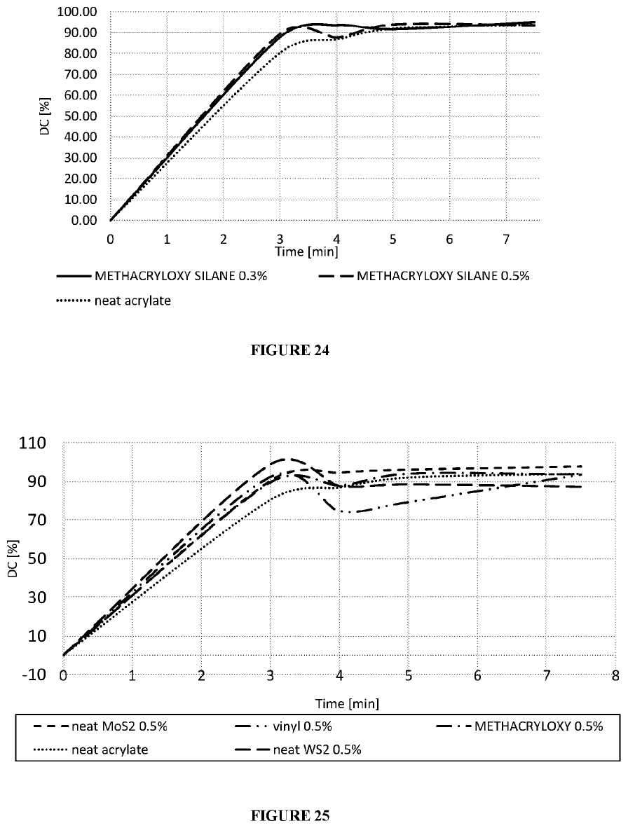

FIG. 24 shows photocuring of MoS₂ with methacryloxy silane treatment. For a concentration of 0.3 wt % a degree of conversion of 94% is reached under UV radiation. At 7.5 mins a 95% conversion is reached for 0.5 wt %.

FIG. 25 shows the degree of conversion at 0.5 wt % MoS₂ compared to neat acrylate.

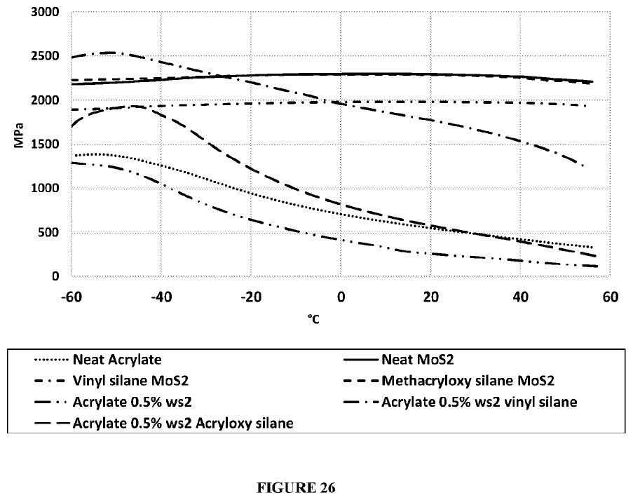

FIG. 26 shows the storage modulus for 0.5 wt % of MoS₂ and WS₂ at different temperatures.

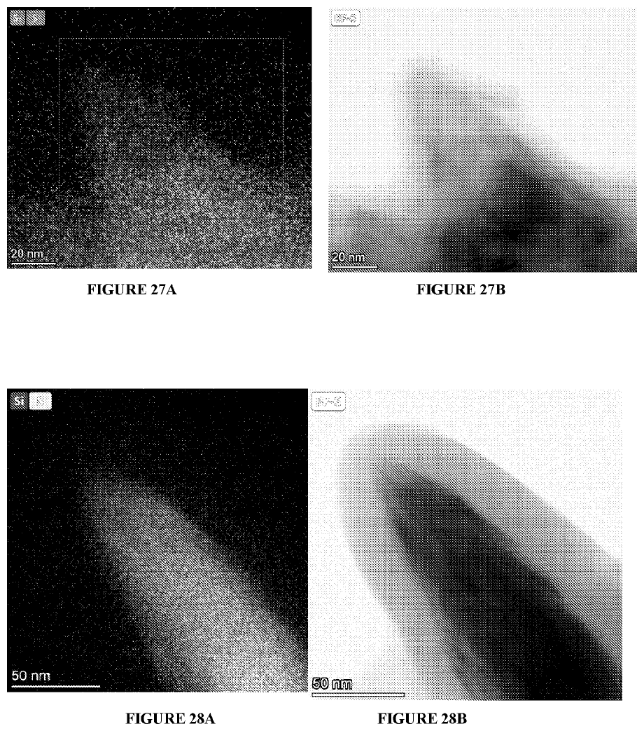

FIG. 27 shows the surface modification of MoS₂ with vinyl silane. FIG. 27A and FIG. 27B shows the EDS and TEM results respectively. Table 6 below shows the elemental analysis from results pertaining to the surface modification of MoS₂ with vinyl silane of the EDS of FIG. 27A:

TABLE 6
Elemental analysis for surface modification
of MoS₂ with vinyl silane

| | | | Atomic | Atomic | Mass | Mass | Fit |
|---|---|---|---|---|---|---|---|
| | | | Fraction | Error | Fraction | Error | error |
| Z | Element | Family | (%) | (%) | (%) | (%) | (%) |
| 8 | O | K | 6.85 | 1.31 | 2.30 | 0.24 | 0.36 |
| 14 | Si | K | 4.04 | 1.09 | 2.38 | 0.52 | 0.34 |
| 16 | S | K | 62.70 | 16.70 | 42.17 | 8.99 | 0.54 |
| 42 | Mo | K | 26.41 | 6.05 | 53.15 | 8.71 | 0.16 |

In a similar manner, FIG. 28 shows the surface modification of MoS₂ with acryloxy silane. FIG. 28A and FIG. 28B shows the EDS and TEM results respectively. Table 7 below shows the elemental analysis from results pertaining to the surface modification of MoS₂ with acryloxy silane of the EDS of FIG. 28A:

TABLE 7
Elemental analysis for surface modification
of MoS₂ with acryloxy silane

| | | | Atomic | Atomic | Mass | Mass | Fit |
|---|---|---|---|---|---|---|---|
| | | | Fraction | Error | Fraction | Error | error |
| Z | Element | Family | (%) | (%) | (%) | (%) | (%) |
| 8 | O | K | 12.09 | 2.19 | 4.17 | 0.42 | 0.57 |
| 14 | Si | K | 4.56 | 1.20 | 2.76 | 0.60 | 0.58 |
| 16 | S | K | 57.56 | 14.97 | 39.76 | 8.42 | 1.01 |
| 42 | Mo | K | 25.80 | 5.71 | 53.31 | 8.63 | 0.19 |

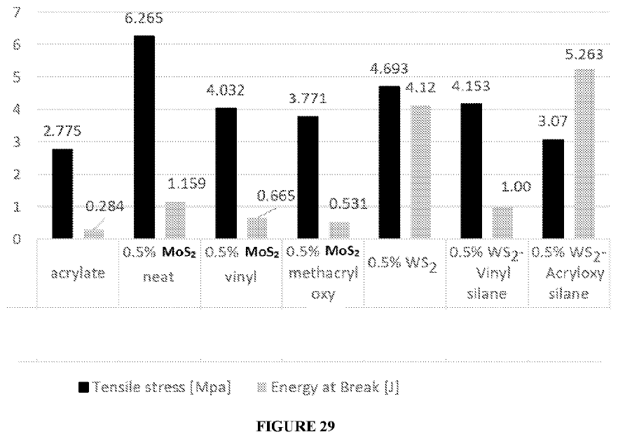

FIG. 29 shows lap-shear results for various surface treatments of 0.5 wt % on MoS₂ and WS₂ to compare between the two. Neat MoS₂ shows enhancement of more than 100% in tensile strength and up to 300% in energy at break compared to neat acrylate. Neat MoS₂ showed an enhancement of 25% in tensile strength compared to acrylate and 0.5% WS₂. The energy to break decrease by 400-450% for MoS₂ compared to WS₂.

In one embodiment, the term “a” or “one” or “an” refers to at least one. In one embodiment the phrase “two or more” may be of any denomination, which will suit a particular purpose. In one embodiment, “about” or “approximately” may comprise a deviance from the indicated term of +1%, or in some embodiments, −1%, or in some embodiments, ±2.5%, or in some embodiments, ±5%, or in some embodiments, ±7.5%, or in some embodiments, ±10%, or in some embodiments, ±15%, or in some embodiments, ±20%, or in some embodiments, ±25%.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. (canceled)

2. (canceled)

3. (canceled)

4. (canceled)

5. (canceled)

6. (canceled)

7. A radical-curable composition comprising at least one monomeric radical curable unit, and at least one photo initiator wherein the photo-initiator consists essentially of inorganic fullerene-like nanoparticles, or inorganic nanotubes; wherein the inorganic fullerene-like nanoparticles or inorganic nanotubes are semiconducting represented by A₁₋ₓBₓ-chalcogenide where A is a metal or a transition metal or an alloy of metals or transition metals including at least one of the following: Mo, W, Re, Ti, Zr, Hf, —Pt, Ru, Rh, In, Ga, WMo, TiW; and B (dopant) is a metal or a transition metal selected from the following: W, Mo, Sc, Y, La, Hf, Ir, Mn, Ru, Re, Os, V, Au, Rh, Pd, Cr, Co, Fe, Ni; x is 0 or between 0 and 0.003; and the chalcogenide is selected from the S, Se and Te.

8. The composition of claim 7, wherein the photo initiator is in an amount of between 0.3% to 1% by weight of the monomeric radical curable unit.

9. (canceled)

10. The composition of claim 9, wherein the monomeric radical curable unit comprises an acrylate.

11. The composition of claim 10, wherein the acrylate is methacrylate, diacrylate, epoxy acrylate, methyl acrylate or combination thereof.

12. (canceled)

13. The composition of claim 10 , wherein the monomeric radical curable unit comprises an acrylate in combination with epoxy, urethane, silicone or copolymer thereof.

14. The composition of claim 7, wherein the composition further comprises an additional photo-initiator selected from aryldiazonium salt, triarylsulfonium salt and diphenyliodonium, conjugated ketones, and triazine-yl derivatives.

15. (canceled)

16. The composition of claim 7, wherein the nanoparticles or nanotubes are homogenously dispersed within the polymeric resin.

17. A method of preparing a thermoset resin, wherein the method comprises radiation curing of at least one monomeric radical curable unit in the presence of least one photo-initiator of claim 7; wherein the radiation curing is conducted at a wavelength of between 350 nm to 420 nm.

18. The method of claim 17, wherein the photo-initiator comprises WS₂ or MoS₂ nanoparticles or a combination thereof.

19. The method of claim 17, wherein the inorganic fullerene-like nanoparticles or inorganic nanotubes are coated by a silane moiety.

20. The method of claim 19, wherein a silane group of the silane moiety is covalently attached to the nanoparticles or nanotubes and the hydrophobic end of the silane moiety interacts covalently with resin/matrix.

21. (canceled)

22. The method of claim 17, wherein the photo-initiator is in an amount of between 0.3% to 1% by weight of the composition.

23. (canceled)

24. The method of claim 17, wherein the monomeric radical curable unit comprises an acrylate.

25. (canceled)

26. The method of claim 17, wherein the composition further comprises an additional conventional photo-initiator selected from aryldiazonium salt, triarylsulfonium salt and diphenyliodonium, conjugated ketones, and triazine-yl derivatives.

27. The method of claim 17, wherein the method comprises mixing the photo radical initiator and the at least one monomeric radical curable unit, optionally by sonication and/or vortex mixing.

28. The method of claim 17, wherein the nanoparticles or nanotubes are homogenously dispersed within the polymeric resin.

29. claim The method of claim 17 wherein the degree of conversion (DC) is above 80%.

30. The method of claim 29, wherein radiation curing of monomeric acrylate provided a degree of conversion of above 90% conversion.

31. (canceled)

32. (canceled)

33. A resin comprising a thermoset polymer and inorganic fullerene-like nanoparticles or inorganic nanotubes are semiconducting represented by A₁₋ₓBₓ-chalcogenide where A is a metal or transition metal or an alloy of metals or transition metals including at least one of the following: Mo, W, Re, Ti, Zr, Hf, Pt, Ru, Rh, In, Ga, WMo, TiW; and B (dopant) is a metal or a transition metal selected from the following: Si, W, Mo, Sc, Y, La, Hf, Ir, Mn, Ru, Re, Os, V, Au, Rh, Pd, Cr, Co, Fe, Ni; x is between 0 to 0.003; and the chalcogenide is selected from the S, Se and Te; wherein the thermoset resin is prepared by radical curing of the corresponding monomeric unit of the polymer and the nanoparticles or nanotubes are used as photo-initiators.

34. Ink for 3D printing comprising the resin of claim 33.

35. (canceled)

36. (canceled)

37. (canceled)
